(19) United States
(12) Patent Application Publication
(10) Pub. No.: US 2011/0060457 A1
(43) Pub. Date: Mar. 10, 2011

(54) Device for Dispensing Solid Preparations

(75) Inventors: Gerhardus Johannes Antonius De Vrught, El Urmond (NL); Josephus Johannes Antonius Geboers, Valkenswaard (NL)

(73) Assignee: DSM IP ASSETS B.V a corporation

(21) Appl. No.: 12/809,240

(22) PCT Filed: Dec. 19, 2008
(86) PCT No.: PCT/EP2008/010917

§ 371 Date: Nov. 23, 2010

(30) Foreign Application Priority Data
Dec. 21, 2007 (EP) 07024898.4
Jan. 21, 2008 (EP) 08100672.8
Dec. 12, 2008 (EP) 08171578.1

(51) Int. Cl. G06F 17/00; B65D 83/04; B65G 59/00

(52) U.S. Cl. 700/241; 221/208; 221/153; 221/258; 221/2; 700/244; 700/231

(57) ABSTRACT

The invention relates to a dispenser, especially for dispensing solid preparations, comprising a housing having a dispensing orifice, and a collar member having a receiving opening, and a passage member, having a receiving chamber, which should be improved in respect to proper dispensing a single unit dose of a substance when required. This object is reached by a dispenser (1, 201, 301, 401, 501, 601) wherein the housing (3, 203, 303, 403, 503, 603), and the passage member (5, 205, 305, 405, 505, 605) are, preferably jointly, movable relative in respect to the collar member (9, 209, 309, 409, 509, 609) between a first position with the receiving chamber (2, 202, 302, 402, 502, 602) being in receiving communication with the receiving opening (4, 204, 304, 404, 504, 604) of the collar member (9, 209, 309, 409, 509, 609) and a second position with the receiving chamber (2, 202, 302, 402, 502, 602) being in dispensing communication with the dispensing orifice (6, 206, 206, 406, 506, 606) of the housing (3, 203, 303, 403, 503, 603).

The invention relates to a dispenser, especially for dispensing solid preparations, comprising a housing having a dispensing orifice, and a collar member having a receiving opening, and a passage member having a receiving chamber. The invention further relates to a dispenser device, comprising such a dispenser and a container being in dispensing communication therewith. Further the invention refers to a dispenser system comprising such a dispenser and/or such a dispenser device, comprising an electronic circuit and/or an energy supply. Further the invention relates to a system comprising such a dispenser and/or such a dispenser device and/or such a dispenser system.

The invention further relates to a use of at least one of a dispenser and/or a dispenser device and/or a dispenser system.

Further the invention relates to a container, especially a medication container.

Finally, the invention relates to a method of monitoring a patient's medication compliance using at least one of a dispenser and/or a dispenser device and/or a dispenser and/or a system.

Such kinds of dispensers, dispenser devices, dispenser systems and systems are used for dispensing solid preparations stored and contained in a container, which is permanently or which will be brought into a dispensing communication with a dispenser. Solid preparations may be medical or pharmaceutical preparations, nutritional preparations, confectionary preparations and all other kinds of solid materials, which are of a solid configuration. Such preparations may be pills, capsules, tablets, particles, pallets, agglomerations etc. One special field for application of solid preparations is the field of medication. Here solid pharmaceutical preparations are generally prescribed by a physician to the patient; however some pharmaceutical preparations can be obtained without prescription (so-called “over-the-counter medication”). Whether the medication is prescribed by a physician or obtained over-the-counter, best results are generally obtained when the medication is taken at regular intervals so that the effective ingredient in the medication is replenished at regular and precise intervals.

Daily or otherwise regular usage is not only important in the normal use of medication so as to have as regular a dosage pattern as possible, but it is even more important in clinical trials. Before any drug is allowed to be prescribed by a physician, the drug must be registered at local agencies, such as the FDA (Food and Drug Administration) in the USA and the European Medicines Agency (EMEA) in Europe. Only after registration may the drugs be put on the market and prescribed and sold for pharmaceutical preparations. To pass the registration procedure, large amounts of data regarding the drug need to be collected and supplied to the authorities. One part of these data is the result of clinical trials. In several phases of the clinical trials, patients are administered a certain dose of the drug. The effects of the drug on the patient are carefully followed, so as to be able not only to determine the effect of the drug but also possible side effects. For the correct determination of the side effects, it is important that the patient strictly follows the prescribed medication regime, or in other words that he/she complies with the regime. When he/she deviates from the regime he/she is considered not to be compliant. The consequence of non-compliant behavior will strongly depend on the kind of drug he/she was taking. With some drugs, the effect may not be serious, while with others, it can lead, for example, to symptoms of poisoning. When a patient who is participating in a clinical trial shows these symptoms of poisoning, the conclusion could, possibly erroneously, be drawn that the symptoms of poisoning and the poisoning itself are adverse effects of the drug itself. Therefore it would be an advantage to the patient, researcher and physician participating in the clinical trials to be able to follow the patient's compliance behavior.

Another factor influencing a patient's compliance is posed by new developments in therapeutics, such as the use of cocktails of pharmaceuticals and the use of chrono-therapeutics. Since the recent discovery that combinations of pharmaceuticals are more effective than mono-therapies in treating AIDS, some cancers and infectious diseases, some of these patients need to take considerable numbers of pills each day without missing doses, else resistance to treatment could develop. Chrono-therapeutics are used for illnesses that fluctuate with the biological rhythm of a patient such as for example asthma. Asthma is often more severe at night than during the day. Therefore it is not necessary to administer a steady dose. A preferred treatment should match the medicine levels to the symptoms. This is exactly what can be done with chrono-therapeutics. However it is essential that the patient is very precise in complying with the prescribed (time) scheme.

Patients sometimes tend to forget their medication. This forgetfulness is strongly dependent on external factors, such as for example holidays, traveling through different time-zones and stress. So patients that experience these situations more often are at a higher risk for non-compliance. Another group of patients with an increased risk for non-compliance are patients with a chronic disease. The chronic disease causes the character of the medication also to be chronic. As it is easier to obey prescription rules for only 10 days than for 10 years, especially patients with a chronic disease may have difficulties in complying with the medication regime as prescribed by their physician.

Again another group of patients with an increased risk of non-compliance are elderly people who suffer from forgetfulness.

All the factors mentioned above in addition to the recent developments can make it difficult for a patient to take his medication right in time; that is: to comply with the medication regime prescribed by the physician. This is reflected in the fact that less than 70% of prescribed medication is actually consumed. For chronic diseases, such as for example hypertension and diabetes this is even lower: approximately 50%. When diseases or conditions are treated sub-optimally, symptoms and complications may worsen, leading to increased use of hospital and emergency services, office visits and other medical resources. Increased adherence may generate medical savings that more than offset the associated increases in drugs costs. In addition to the costs, medication that is prescribed but not consumed must be disposed of in a sensible way, giving rise to additional costs. The non-consumed medication can pose a health risk when it is not brought back to the pharmacy or is not disposed of in another sensible way. For example a child can get hold of it and think it is candy and eat it with all the health risks going with it. Or the presence of the medication in some system can generate immunity against the active ingredient in the medication.

For the reasons described above, either separately or combined, it would be desirable to have means available to aid a patient, researcher, physician and/or pharmacist to increase the rate of compliance for taking medication and possibly not only increase the rate, but also increase the convenience, that is “the ease” with which compliance can be reached. In addition to the mentioned persons, it could also be advantageous for family and/or friends and/or other care takers around the patient.

Although the advantages are described above in connection to solid pharmaceutical preparations, the advantages can apply fully, or at least partially, to other fields where solid preparations are supplied to or taken by a person. An example of such another field outside the pharmaceutical field is the nutritional field, or the field of confectionary. The device according to the present invention can equally well be used in these and other fields; it is not limited to the pharmaceutical field. Therefore, the term “dispenser” refers to a device in a very brought sense as well as the term “solid preparation” and they cover all applications and application forms as mentioned before and hereafter.

The wording “solid preparation” is meant to encompass each and any form of solid dosage of a certain pre-determined amount and shape. With solid dosage is meant a dosage that during normal use by the user, such as for example a patient, retains its shape. It encompasses a dosage of a liquid or liquid-like substance that is captured within a solid skin. Examples of solid preparations are tablets, dragees, capsules and pills. Examples of solid preparations with a liquid or liquid-like substance captured in a solid skin are dragees with a gel-like substance contained in it. With solid pharmaceutical preparation is meant a solid preparation containing at least one pharmaceutically active compound. With solid nutritional preparation is meant a solid preparation containing at least one nutritionally active compound.

A dispenser for medication is known from US2006/0283876. The dispenser according to US2006/0283876 comprises elements that can indicate the moment the medicament should be dispensed and it contains means to initiate an alarm at the moment that the medicament should be taken according to a pre-set frequency scheme. This dispenser can therefore help a patient to take the medicament at regular pre-set intervals according to a pre-set frequency.

A disadvantage of the dispenser according to US2006/0283876 is that it is impossible to analyze the patient's compliance to the pre-set medication regime. Some kinds of medication need to be taken at very strict intervals. Not obeying this regime can cause severe harm to the patient. Therefore the availability of this kind of information would be very helpful to, for example emergency doctors when the patient, due to the non-observance, needs to be brought to the hospital.

A dispenser, especially for dispensing solid preparations, comprising a housing having a dispensing orifice, and a collar member having a receiving opening, and a passage member having a receiving chamber, is known from the U.S. Pat. No. 2,962,190 A. This document discloses a dispenser wherein a receiving chamber comprising a receiving opening and a dispensing opening is movable arranged within a housing, wherein in a first position the receiving opening of the receiving chamber is in a receiving communication with a housing providing the solid preparations and wherein the receiving chamber is in a second position providing a dispensing communication between its dispensing opening and a dispensing orifice of the housing. It is a disadvantage of this known dispenser that the compartment of the receiving chamber receiving the solid substances or preparations which shall be dispensed may receive more than one of these solid preparations. Thus, it is difficult or nearly impossible to assure that only one single dose will be dispensed.

A dispenser and/or a dispenser device and/or a dispenser system comprising an electronic circuit and/or an energy supply for monitoring, controlling and/or communication as well as a method of monitoring a patient's medication compliance using a dispenser is known from WO 2007/081947 A. This known device and method comprises the use of a relatively complex constructed dispenser which might be improved under convenience aspects.

The present invention also relates to a method of monitoring a patient's medication compliance. Such a method involves utilizing an automatic compliance monitoring device, which tracks patient compliance data, along with a wave energy transmitter and power source. A receiver is connected to a computer. The dispenser or the computer is programmed to calculate compliance requirements by for example the number of cap openings. Such a method is known from EP 0 526 166 A1.

A disadvantage of the method described in EP 0 526 166 A1 is that the compliance determination is vulnerable to manipulation, either deliberately or accidentally. For example when a patient opens his medication bottle to see how many pills are still in there and to determine whether he has to ask for a refill, the automatic compliance monitoring device records an opening of the bottle and records, falsely, compliance.

Solid pharmaceutical preparations and/or solid nutritional preparations and/or solid confectionary preparations pose certain requirements on the atmosphere wherein they are contained. When the quality of the atmosphere surrounding the solid pharmaceutical preparations and/or solid nutritional preparations and/or solid confectionary preparations is not sufficient a reasonable shelf life can't be obtained. With a reasonable shelf life is meant a period of usually between six months and three years, typically at least two years. One factor influencing the quality of the atmosphere within the container is the relative humidity. Relative humidity (RH) has here and hereinafter its usual meaning, being the ratio of the actual humidity over the saturated humidity at the same temperature. To reach the reasonable shelf life indicated above, the relative humidity inside the container has generally to be maintained below 50%, preferably less than 40%, more preferably less than 30%.

A container for holding solid pharmaceutical preparations is known from US2007/0163917. US2007/0163917 describes a package for pharmaceutical dosage forms, wherein the pharmaceuticals inside pose certain requirements on the level of oxygen and moisture present in the package. The pharmaceutical dosages are packed in a bottle. To decrease or at least maintain the oxygen level in the bottle at an acceptable level, a self-activated metal-based oxygen absorber is placed in one sub-container. To decrease or at least maintain the moisture level in the bottle at an acceptable level, a desiccant is placed in another, second, sub-container. The sub-container with the desiccant is covered on both open ends with membranes so as to allow the air in the container to enter the desiccant sub-container. The sub-containers can be separate units or unitary, that means they are fabricated together as separate compartments within a single unit.

A disadvantage of the construction chosen in US2007/0163917 is that the production process is difficult as first a bottle must be constructed, wherein at least two separate sub-containers must be placed. Additionally the filling of the bottle with the pharmaceutical dosages is difficult as the bottle already contains the sub-containers.

It is an object of the present invention to overcome or at least diminish the above mentioned disadvantages and to provide a solution for proper dispensing a single unit dose of a substance when required.

It is another object of the invention to provide means for increasing the rate of patient's compliance.

It is another object of the invention to control and/or monitor relative humidity and/or temperature in a dispensing system. This object is achieved by a dispenser, especially for dispensing solid preparations, comprising a housing having a dispensing orifice and a collar member having a receiving opening, and a passage member, having a receiving chamber, wherein the housing and the passage member are, preferably jointly, movable relative in respect to the collar member between a first position with the receiving chamber being in receiving communication with the receiving opening of the collar member, and a second position with the receiving chamber being in dispensing communication with the dispensing orifice of the housing.

This object is also reached by a dispenser device according to claim 16, a dispenser system according to claim 25, a system according to claim 31, a use according to claim 33, a method of monitoring according to claim 27, a method of monitoring according to claim 34, a method of monitoring according to claim 37, and a container according to claim 18. Favourable and advantageous embodiments of the invention are part of the respective depending claims.

The invention provides a dispenser, which allows the dispensing of a substance, especially a solid preparation, in a unit dose manner. Due to the relative movement of the housing together with the collar member between a first position wherein the receiving opening of the collar member is in receiving communication with the receiving chamber of a passage member and a second position wherein the receiving chamber is in dispensing communication with the dispensing orifice of the housing it is possible to design and form a dispensing channel or dispensing part or way of dispensing which only allows one unit dose or substance to be delivered from the receiving opening of the collar member to the receiving chamber of the passage member and from the receiving chamber of the passage member to the dispensing orifice of the housing—during each dispensing action—to reach and achieve this object it is one possibility that the housing and the passage member are, preferably jointly, movable relative in respect to the collar member. Thus, it is possible to have the collar member positioned, for instance by screwing, on a dispensing orifice of a preferably well known and commonly used container containing the respective solid substance, and then dispense the solid preparation by using the dispenser according to the invention. Such a dispenser device provides a dispenser, which is in permanent receiving and/or dispensing communication with the respective container.

It is further possible to provide the dispenser and/or the dispenser device with electronic means for monitoring, controlling and data communication, which additionally enhances therapy compliance. This will provide a dispenser system. Further, it is an advantage of the dispenser, the dispenser system and the dispenser device according to the invention that it is easier to produce and easier to fill with the solid preparations, such as for example pharmaceutical preparations, because it is possible to provide a commonly used container, for example medication bottle, with a dispenser according to the invention.

A dispenser and/or a dispenser device and/or a dispenser system provided with a docking station is referred to as a “system”.

In an advantageously formed embodiment of the invention the receiving chamber comprises or is connected to a guiding passage for connecting the receiving chamber with the dispensing orifice of the housing. To ensure that only one single unit dose can leave this guiding passage, this guiding passage is of a size which does a substance, especially a solid preparation in form of a pill, not allow to pass through. Only in case that this guiding passage is during the movement of the passage member positioned adjacent to a corresponding guiding passage part formed within the housing it is then possible for the substance, especially a solid preparation, to leave the dispenser through the exit opening of the combined elements of the guiding passage and the complementary guiding passage part and then the dispensing orifice of the housing. Therefore, the invention further provides a dispenser wherein a guiding passage for connecting the receiving chamber and the dispensing orifice when the passage member is in its second position is at least partly formed in the housing.

In order to close the guiding passage and/or the receiving opening of the collar member in case that one unit dose of a substance or one solid preparation has already been delivered to the receiving chamber and/or the guiding passage or in case that it is not desired to use the dispenser for dispensing the invention further proposes a dispenser wherein the passage member, which preferably is centrally arranged in the housing closes the receiving opening when reaching its second position.

For the dispensing of a unit dose it is further of advantage, when the receiving chamber is dimensioned for accommodating one unit dose of a solid substance to be dispensed, as also proposed by the invention.

To ensure the delivery and a good guidance of a substance into the direction towards the dispensing opening of the collar member, the invention further provides that the collar member is hopper-like shaped towards the receiving opening and/or comprises a funnel-like designed part extending from the receiving opening.

To support the performing and conducting of the movement of the housing and/or the passage member relative to the collar member between the first position and its second position, it is of advantage to have the support of resilient member. Therefore, the invention is further characterized by a resilient means, especially a coil spring, which is arranged between the housing and the collar member biasing and/or urging them to move the passage member into the first position or the second position. To connect the dispenser with a container it is according to the invention of further advantage to have a dispenser wherein the collar member comprises a circumferential outer fringe at its perimeter providing connecting elements which are suitable for interacting with corresponding connecting elements provided at a, preferably commonly used, container, especially at a dispensing opening of a medication bottle, preferably containing solid pills or capsules.

To ensure that a substance contained in the receiving chamber of the passage member and/or already positioned in the guiding passage will not be dispensed out and leave the dispenser accidentally, the invention additionally provides a closure which releasably closes the dispensing orifice of the housing. For this purpose, the dispenser is further characterized in that the dispensing orifice is releasably closed by a closure. For instance, it is possible to block this closure, which may be a lit or a cap, so that it can only be opened in case that the medicine or substance shall be dispensed.

In many cases it is desirable to avoid that moisture or humidity from the outside environment enters the dispenser and/or the container connected therewith. To avoid this, the invention further proposes a dispenser wherein sealingly interacting parts or elements are arranged between or respectively at the passage member and the collar member and/or between or respectively at the collar member and a container interacting therewith and/or between or respectively at the housing and the collar member and/or between or respectively at the housing and the passage member to provide a moisture tight seal, respectively.

To support this measure, the invention further proposes to have at least one of the housing and/or the passage member and/or the collar member be made at least partly of a desiccant entrained polymer, especially polypropylene or polyethylene. This allows to make the housing, the collar member and the passage member being moisture or humidity absorbing.

To provide a guidance for the passage member the invention further proposes to have a dispenser wherein the collar member provides an inner sleeve surrounding a perimeter of the passage member to accommodate and guide the passage member during its movement from the first to the second position and vice versa.

Sometimes it is important to identify whether a solid substance, such as a pill or a capsule, has already been and really been dispensed out of the dispenser. To ensure this, the invention proposes a dispenser further comprising a detector for monitoring the dispensing of each substance and/or particle, particularly a solid preparation, dispensed.

To allow only dispensing in cases that it is useful and in cases which are in accordance with the time table for taking medications, the dispenser may further comprise a mechanical or electro-mechanical blocking mechanism for releasably blocking relative movement between the movable collar member and the housing and/or between the passage member and the collar member and/or for releasably blocking the closure covering the dispensing orifice.

For controlling, monitoring and communicating all these actions, it is a further feature of the dispenser according to the invention to comprise an electronic circuit and an energy supply for monitoring, controlling, indicating and/or communication.

This also allows to additionally provide a dispenser which comprise at least one element indicating that at least one unit dose of the substance should be dispensed.

As above mentioned the members and elements of which the dispenser consists may be at least partly be made of a desiccant entrained polymer. But this is also favourable in respect to the dispenser device wherein a container is combined with a dispenser, so that the dispenser device is further characterized by the feature that the container is made at least partly of a desiccant entrained polymer, especially polypropylene or polyethylene.

The dispenser device may comprise a container with an absorber function, suitable for holding solid preparations, wherein the absorber function is obtained by an absorber component and wherein the absorber component is an integral component of the material the container is made from. As the absorber component is an integral component of the material it is much easier to fill containers without the obstruction of a separate sub-container. With integral component is meant a component that is incorporated in the container material or in a part of the container material, but also attached to the container material in a manner it can't become detached by simple movement of the container. An example of the last embodiment is a liner or sleeve in the container, whereby the liner/sleeve is connected to the container by for example chemical means such as an adhesive or mechanical means such as for example a notch preventing the sleeve/liner from separating from the container. It is also possible to provide the absorber component during a coextrusion process or in a two step extrusion or blow moulding process.

An additional advantage is that there is no risk of breaking the sub-container. The breakage of the sub-container could release the absorber into the container. A further advantage of the container according to the invention is that there is no risk of falling out of the sub-container. When the sub-container would intentionally or unintentionally be removed, the absorber function is lost and the quality of the solid preparations in the container will quickly decrease, possibly posing health risks when the quality drops below a certain level.

The material of the container for use in the invention which has an absorber function and is suitable for holding solid preparations is preferably a polymer as polymers can easily be processed and formed into any desired shape. The technique of preparing a polymer composition suitable for use as container material or part of the container material is known from for example U.S. Pat. No. 5,911,937 A or U.S. Pat. No. 6,214,255 A which are included by reference. The absorber function in the container is especially suitable for absorbing moisture, gases and/or odors.

The absorbing material in the polymer composition can be chosen from any kind of suitable absorber material. Suitable is meant herein to be suitable for the component to be absorbed. Examples of suitable absorber materials can fall in a number of categories: i) anhydrous salts that tend to absorb water and/or moisture and form a stable salt, ii) reactive compounds that tend to react with water and/or moisture upon the formation of a new species, or iii) absorbers that function via physical absorption for example via their fine capillary morphology. Suitable examples of physical absorbers are molecular sieves, silica gels, clays and starches.

The container, especially when being a medication container may be equipped with an electronic temperature sensor and/or an electronic humidity sensor positioned such that the temperature and/or humidity within the container are measured, wherein the container is further equipped with electronic circuitry that receives readings from the electronic temperature sensor and/or the electronic humidity sensor, and stores and/or transmits said readings to an external device. It is possible that the electronic temperature sensor, and/or the electronic humidity sensor, and/or the electronic circuitry are connected to a dispenser disposed in dispensing communication with the container. Further, it is proposed that the circuitry comprises an alarm device, and wherein an alarm is produced when the temperature sensor and/or the humidity sensor indicates that a solid preparation, especially medication contained in the container is being stored at a temperature and/or humidity that is outside of an acceptable temperature and/or humidity range for said preparation. The circuitry may receive information and/or commands from an external source. Here it is further possible that the information comprises an acceptable temperature and/or humidity range for the solid preparation, especially medication, contained in the container and/or an expiration date for the solid preparation, especially medication, in the container calculated based on the temperature and/or humidity readings sent to the external device. It is also possible that the commands comprise a command to alert the user that the temperature and or humidity readings sent to the external device are outside of an acceptable temperature and/or humidity range. Also, the invention proposes that the container further comprises a blocking device that prevents access to the solid preparation, especially medication, stored in the container, and wherein the commands comprise a command to activate the blocking device to prevent access to the solid preparation, especially medication, if the preparation, especially medication, has been stored at a temperature and/or humidity outside of an acceptable temperature and/or humidity range.

The dispenser system according to the invention comprises a dispenser and/or a dispenser device and/or a container, wherein the dispenser system additionally comprises an electronic circuit and/or an energy supply for monitoring, controlling, indicating and/or communication, especially data communication.

The invention proposes a dispenser system, wherein the electronic circuit comprises: a sensor configured to detect a dispensing event of a single dose of the medication from the dispenser;
a memory that stores information associated with the dispensing event; and
a transceiver that wirelessly transmits the information associated with the dispensing event to an external device.

The invention further disposes a dispenser system wherein the electronic circuit comprises a temperature sensor and/or a humidity sensor positioned to detect the temperature and/or humidity of medication stored in the dispenser and/or the container, wherein the electronic circuit is further configured to communicate information relating to the temperature and/or humidity to an external device.

The invention further disposes a dispenser system wherein the electronic circuit is configured to receive commands from an external device. The invention further disposes a dispenser system wherein the commands comprise a lock and/or an unlock command that causes the dispenser to lock and/or unlock dispensing of medication. The invention further disposes a dispenser system wherein the dispenser communicates with a second dispenser to coordinate the administration of medication from the dispenser and the second dispenser.

Further, the invention refers to a system comprising a dispenser and/or a dispenser device and/or a dispenser system wherein the system further comprises a docking station. An advantageous embodiment of this system further comprises an external data base that stores information sent by the dispenser.

The above-mentioned objects reached and achieved by the use of at least one of a dispenser and/or a dispenser device and/or a dispenser system and/or a system the dispenser device, the dispenser system and/or the system according to the invention is used for monitoring a patient's medication compliance.

The above-mentioned object is also reached or achieved by a method of monitoring a patient's medication compliance which uses at least one of a dispenser and/or a dispenser device and/or a dispenser system and/or a system and/or a container according to the invention and/or preferably comprises
a. providing a dispenser system which dispenser system tracks at least one type of patient medicine compliance data, said dispenser system being connected to a container,
b. providing a wave energy transmitter and a power source to drive said transmitter for transmission of said patient's medicine compliance data to a remote location, said transmitter being electronically connected to said dispenser system for said transmission and said data transmitter and power source or supply being connected to said container,
e. preferably providing a receiver at said remote location and providing a computer to which said receiver inputs patient compliance data,
c. having either said dispenser system or said computer programmed to store the prescribed medicine dosage and regime of said container,
d. having either said device or said computer programmed to calculate compliance requirements for each dosage administration for the prescription period of the medicine and for comparing the actual medicine consumption or container usage with the compliance requirements.

In the method according to the invention a dispenser system is used that is connected to a container, generally a medicine container. The container can either be a well-known medicine container or a container with an absorber function as described above. It is preferred to use a container with an absorber function as this type of container makes it possible to use the container for prolonged periods of time without the medicament loosing quality.

Particular embodiments of the invention will now be described in reference to the accompanying drawings in which:

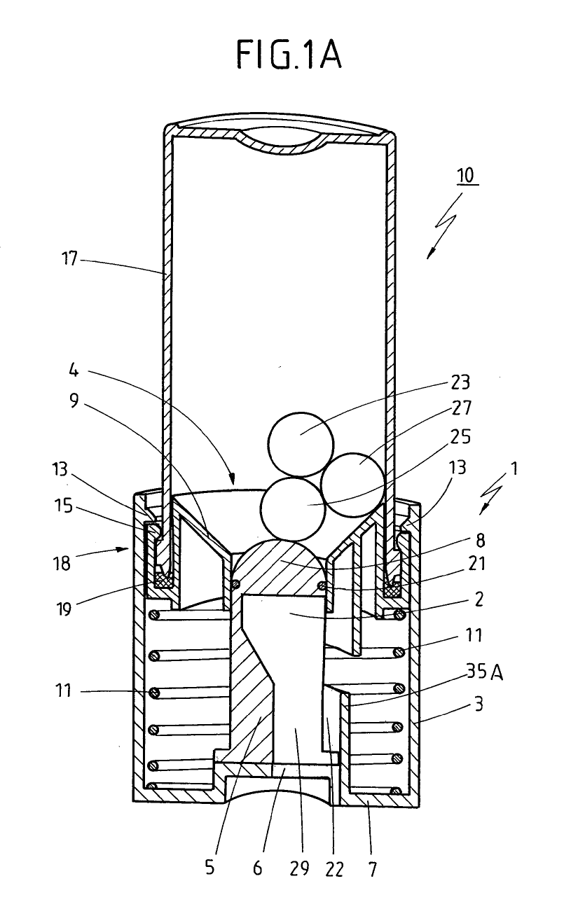

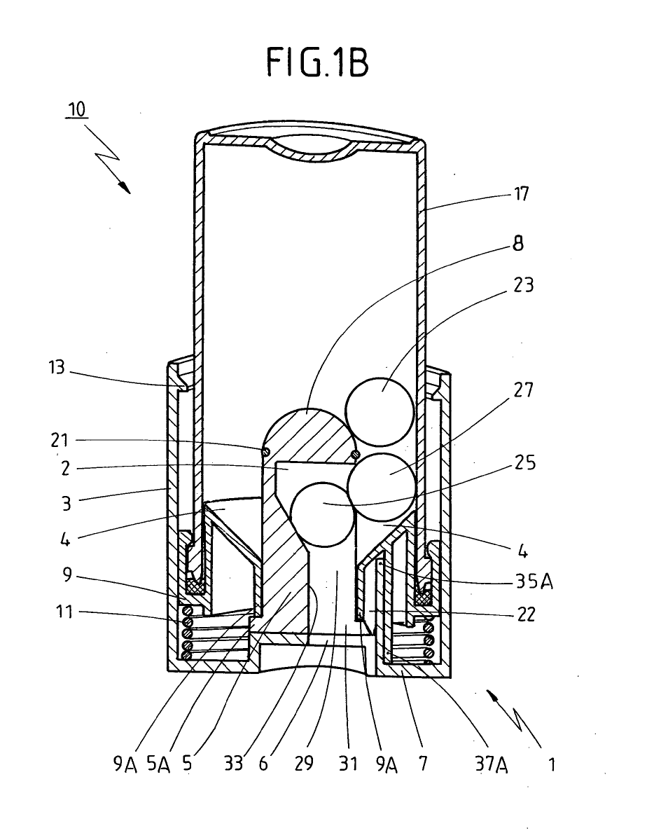

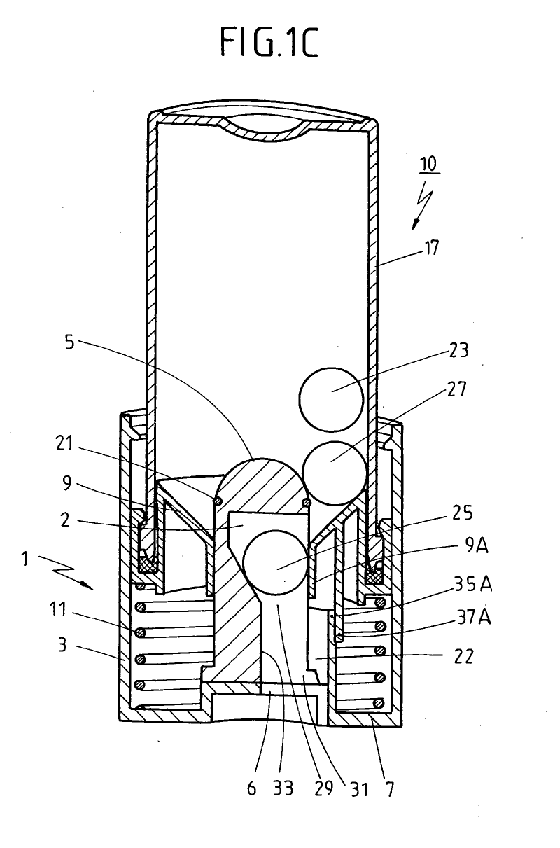

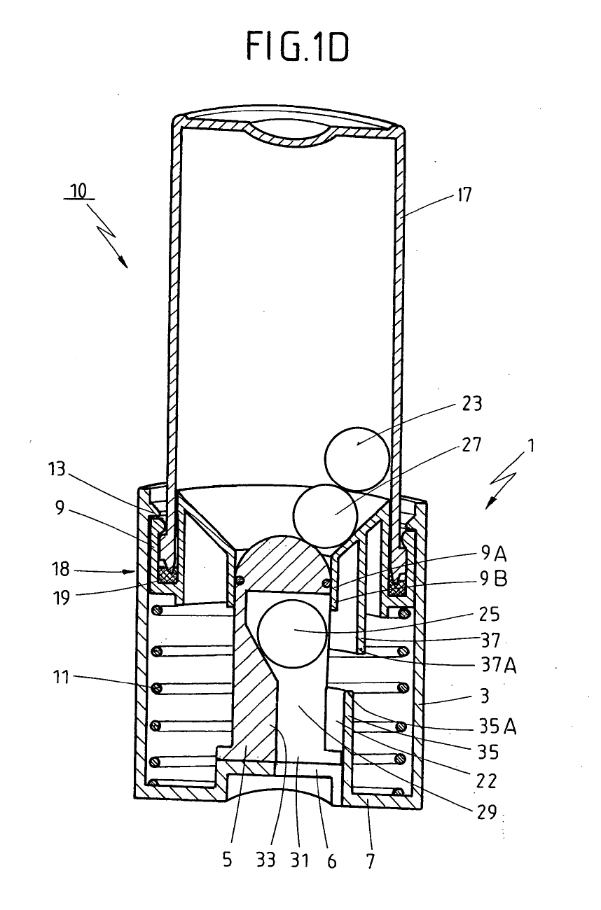

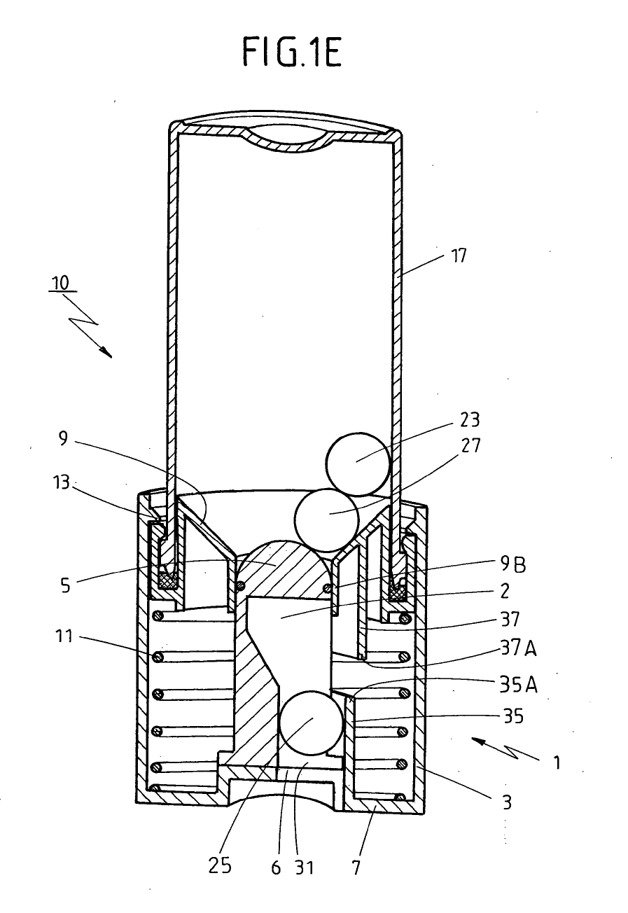

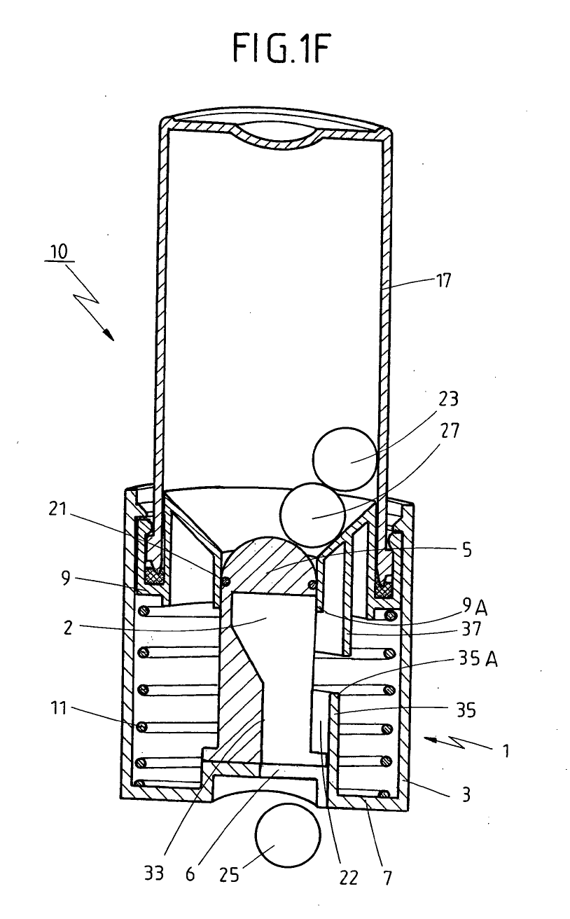

FIG. 1A diagrammatically shows in cross section a dispenser according to the invention in combination with a medicine container in an inactive first position;

FIG. 1B diagrammatically shows the dispenser of FIG. 1A moved into a second position;

FIG. 1C diagrammatically shows the dispenser of FIG. 1A in an intermediate position moving back from the second position to the first position.

FIG. 1D diagrammatically shows the dispenser of FIG. 1A upon returning to its first position;

FIG. 1E/1F diagrammatically show the release of a single pill or tablet after the dispenser of FIG. 1A has returned to the first position;

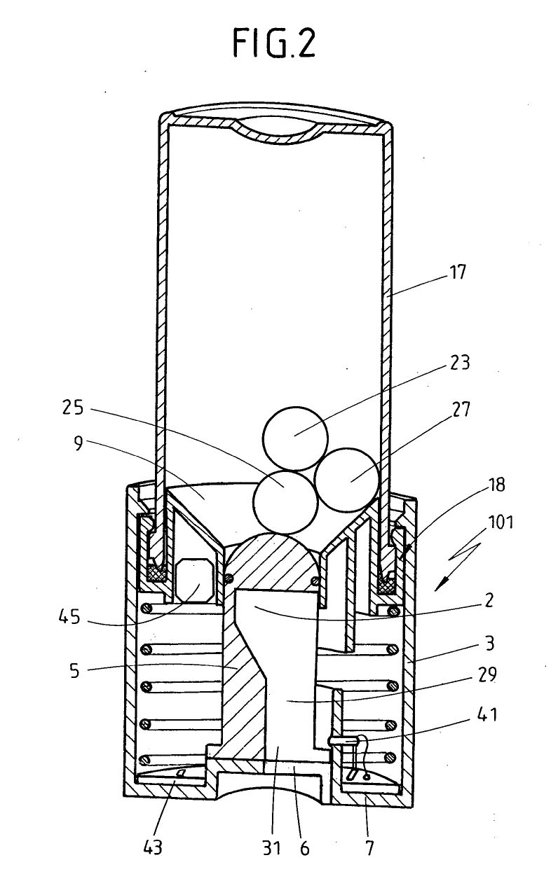

FIG. 2 diagrammatically shows a variation of the dispenser device of FIGS. 1A-1F being provided with additional therapy compliance means, in the form of electronic monitoring and communication means;

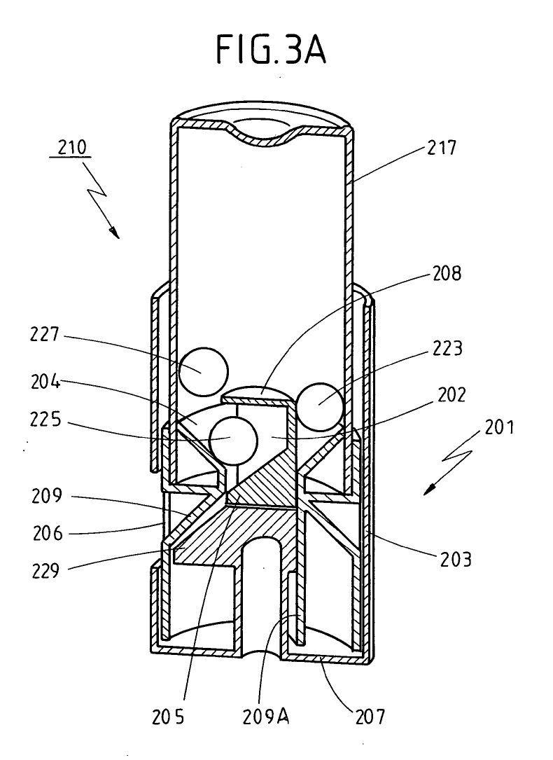

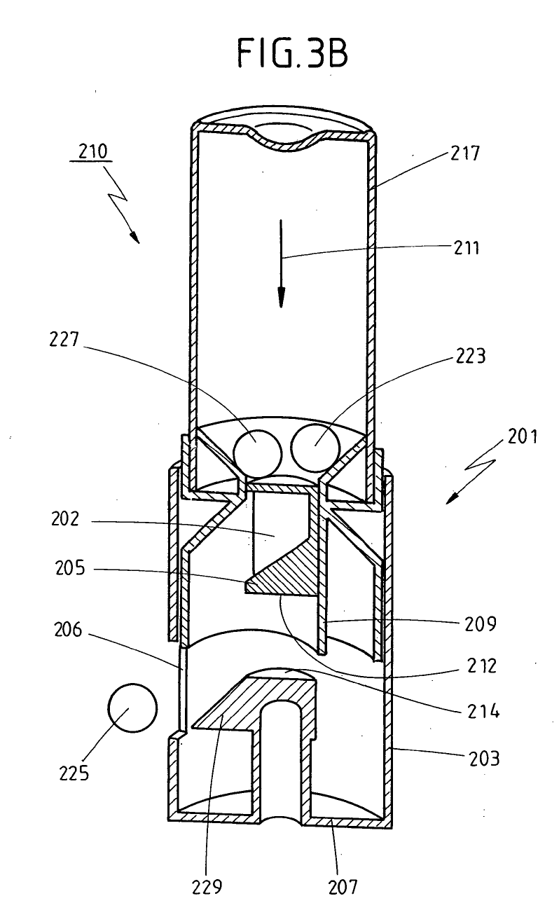

FIG. 3A diagrammatically shows, in cross section, an alternative embodiment of a dispenser according to the invention in a position comparable to FIG. 1B; and

FIG. 3B diagrammatically shows the alternative embodiment of FIG. 3A in a position comparable to that of FIG. 1F,

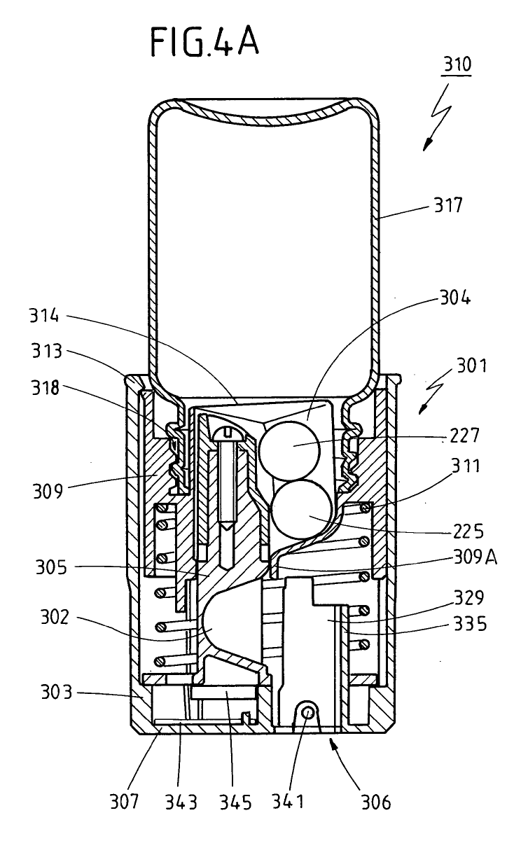

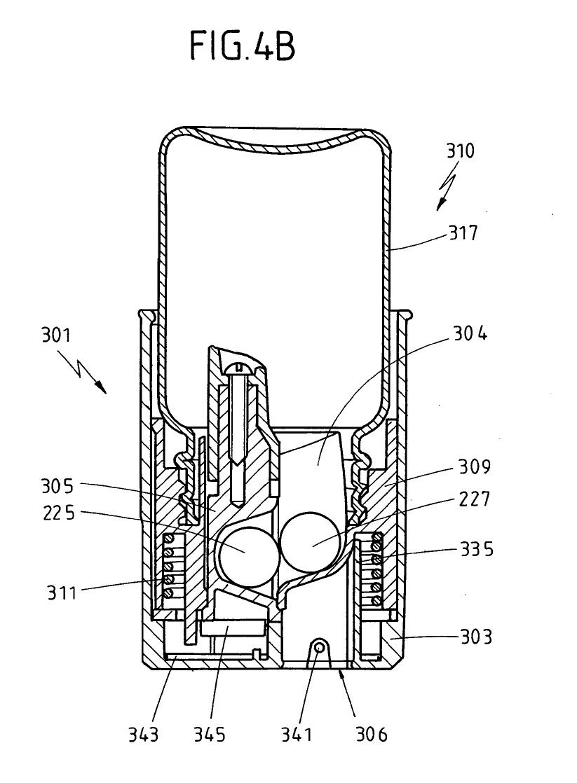

FIG. 4A-4C diagrammatically show a cross section of another alternative embodiment,

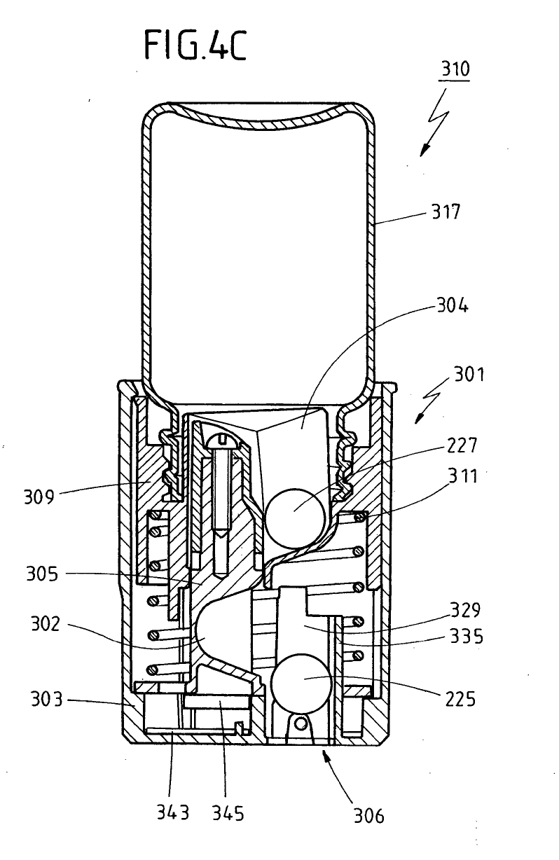

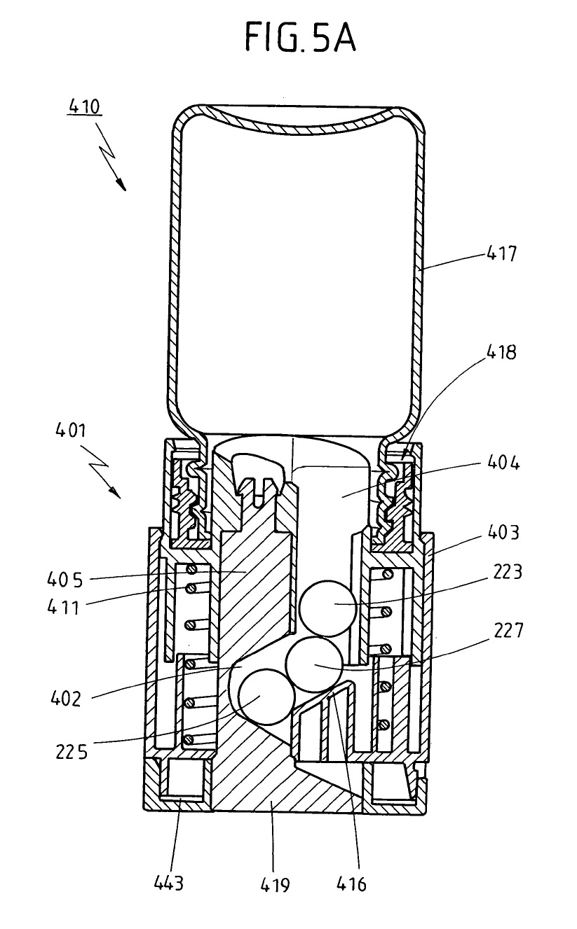

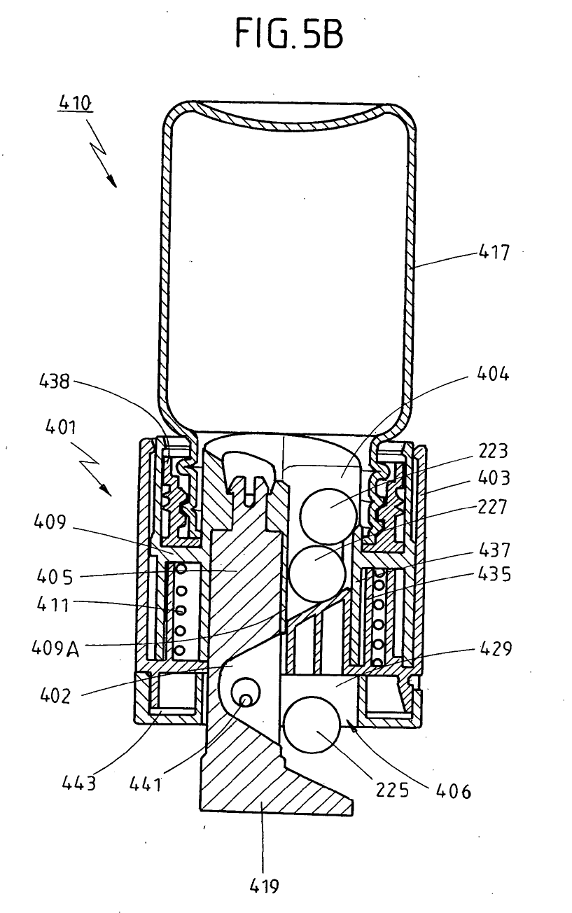

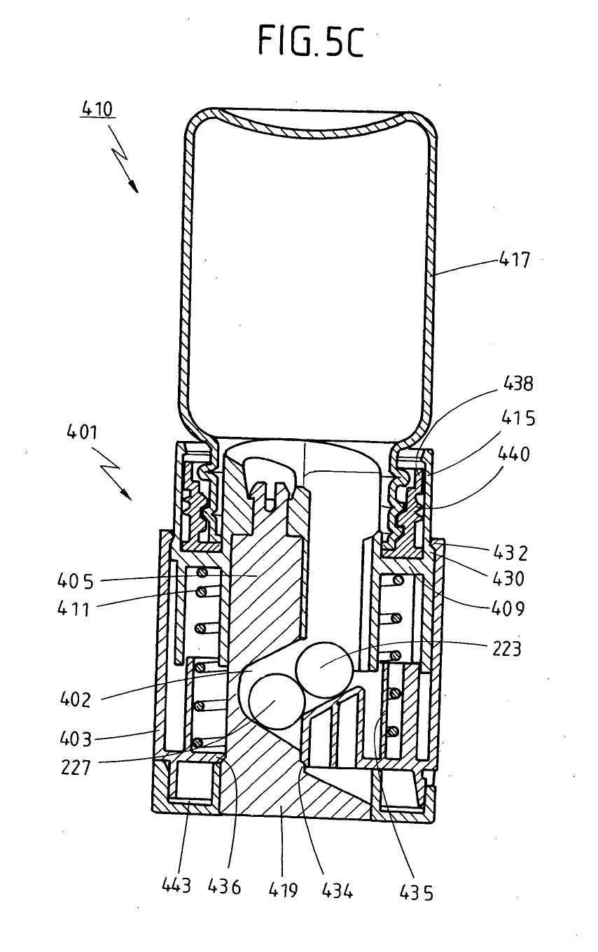

FIG. 5A-5C diagrammatically show a cross section to another alternative embodiment,

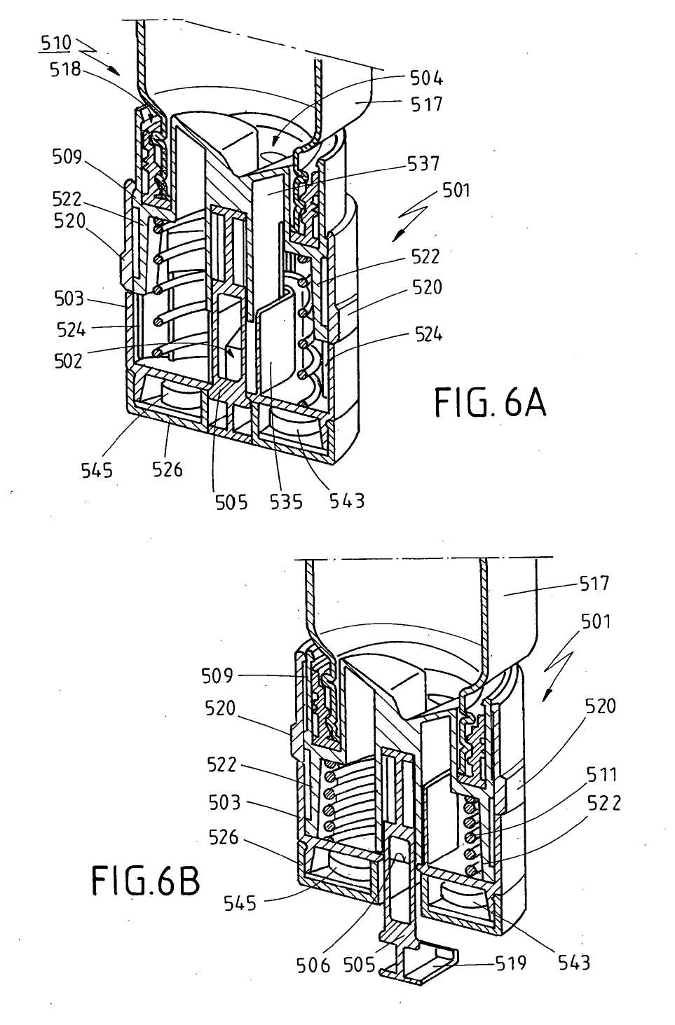

FIG. 6A-6B diagrammatically show a perspective view of a cross section of another alternative embodiment,

FIG. 7 diagrammatically shows a view onto the inner side of a closure cap of the embodiment according to FIG. 6A, 6B,

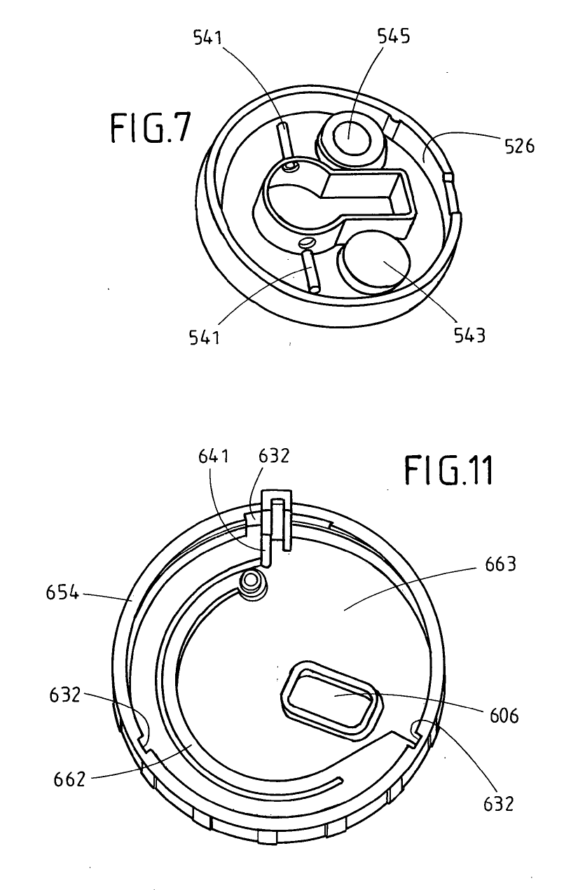

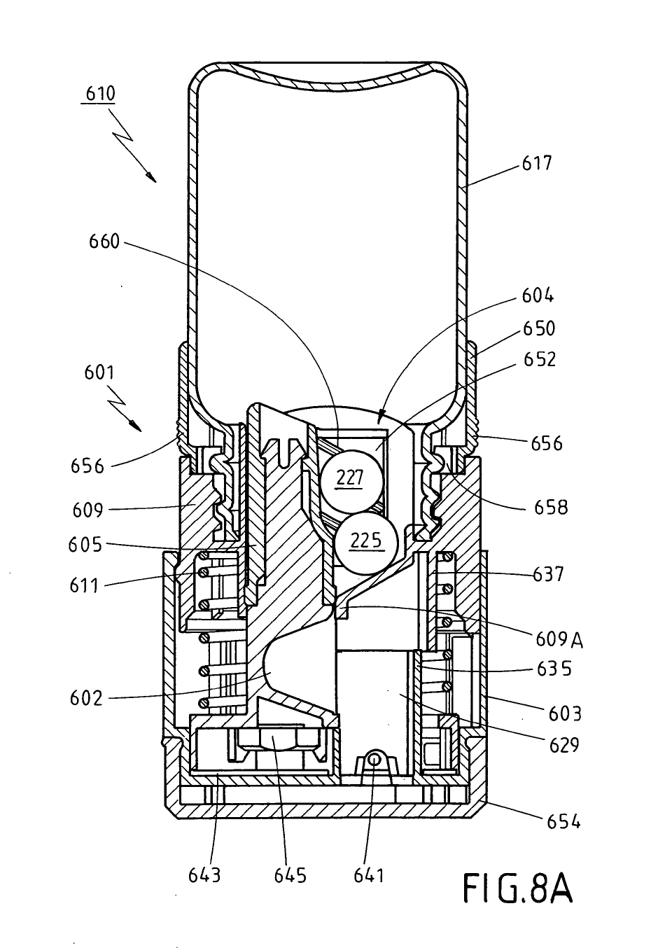

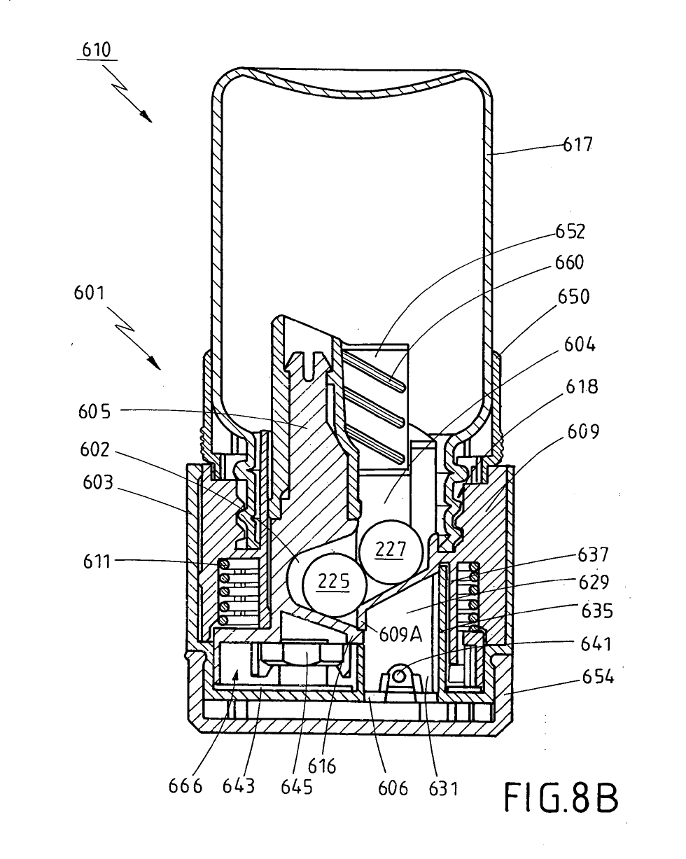

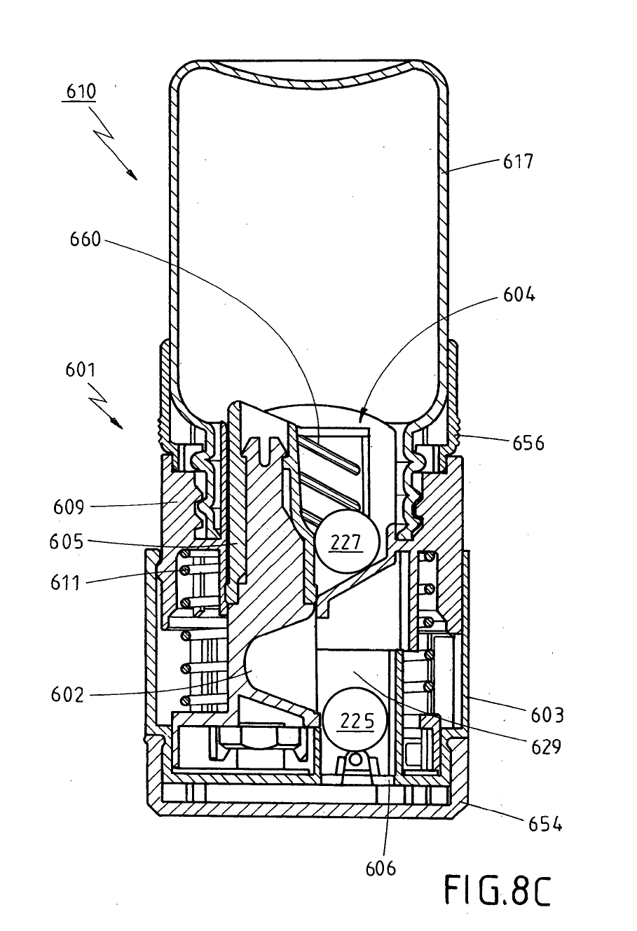

FIG. 8A-8C diagrammatically show a cross section of another embodiment of the invention,

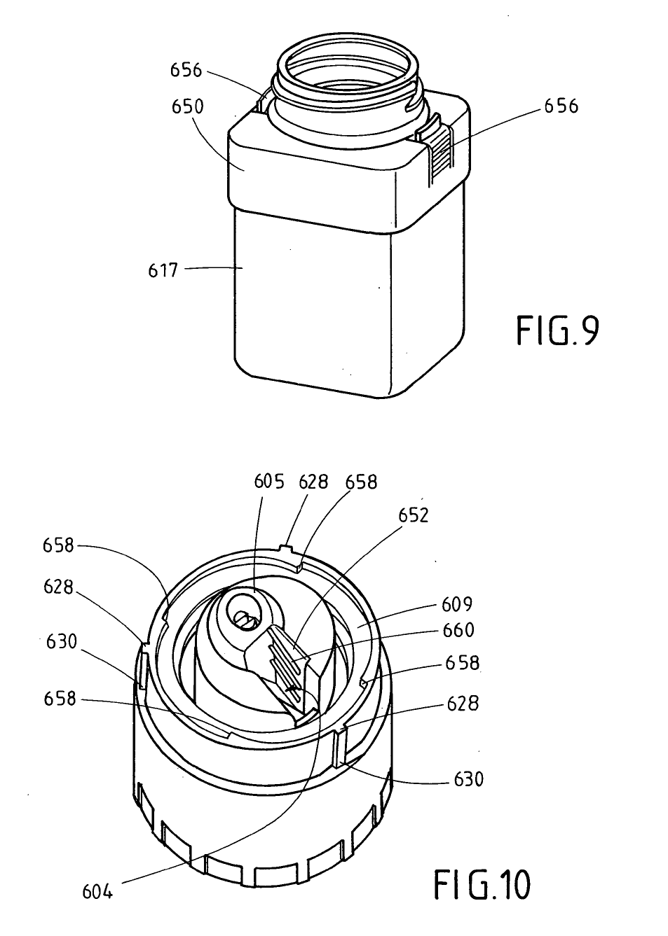

FIG. 9 diagrammatically shows a perspective view onto the container of the embodiment according to FIG. 8A-8C with the collar member removed,

FIG. 10 diagrammatically shows a perspective view onto the inner side of a collar member according to the embodiment of FIG. 8A-8C;

FIG. 11 diagrammatically shows a perspective view on the inner side of a closure cap of the embodiment according to FIG. 8A-8C;

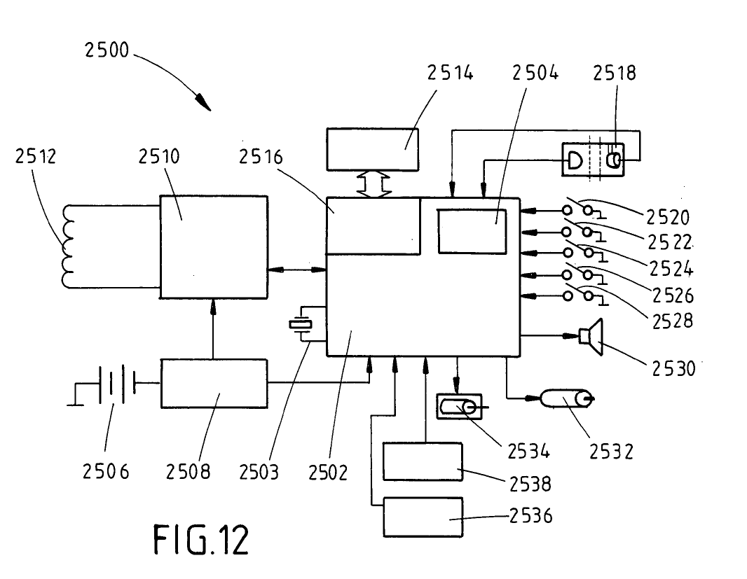

FIG. 12 diagrammatically shows a block diagram of the electronic monitoring and communication means of a dispenser;

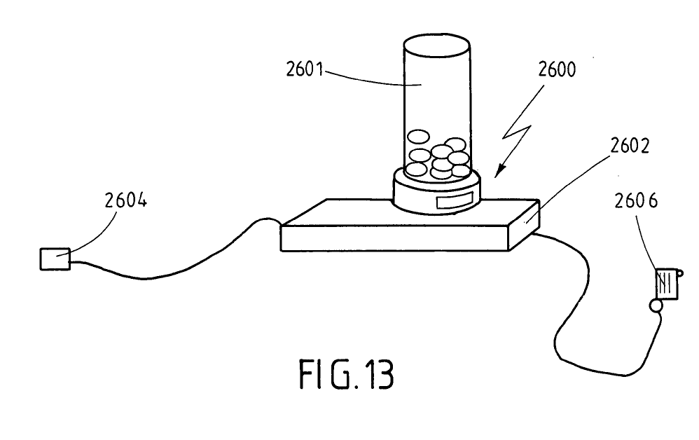

FIG. 13 diagrammatically shows the/a dispenser in association with a docking station for the exchange of monitoring and communication data;

FIG. 14 diagrammatically shows a block diagram of the docking station of FIG. 13; and

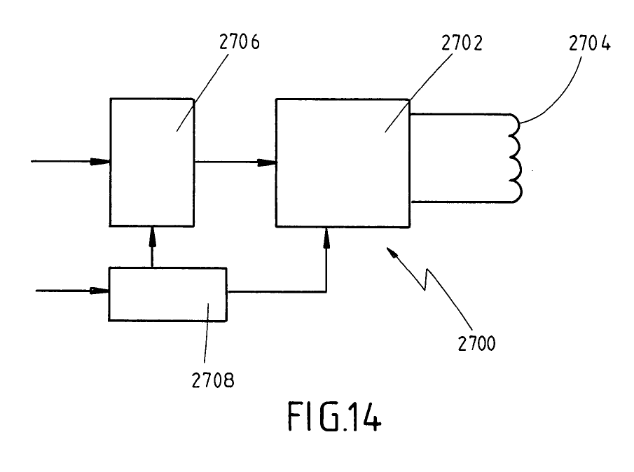

FIG. 15 diagrammatically shows a therapy compliance monitoring and communication system.

In FIG. 1A a dispenser 1 is shown which includes a housing 3. The housing 3 has a substantially hollow interior with a passage member 5 extending from a bottom 7 of the housing 3. Surrounding the passage member 5 is a movable collar member 9, which is urged by a resilient means in the form of a coil spring 11 towards a circumferential detent 13 which is arranged at an upper position of the housing 3 and prevents the movable collar member 9 from escaping from the housing 3. The housing 3 and the passage member 5 are connected to each other and are jointly movable relatively in respect to the collar member 9 as well as the collar member 9, which is attached to a container 17, is relatively movable in respect to the housing 3 and the passage member 5. It is possible to move the housing 3 and the passage member 5 and the collar member 9 against the force of the resilient means, i.e. the coil spring 11, to a first position as shown in FIG. 1B wherein a receiving chamber 2 of the passage member 5 is in receiving communication with a receiving opening 4 of the collar member 9. Likewise it is possible to move the housing 3 and the passage member 5 in a second position as shown in FIG. 1A wherein the receiving chamber 2 is in dispensing communication with a dispensing orifice 6 provided in the housing 3. In this embodiment the coil spring 11 drives or urges the housing 3 and the passage member 5 on the one hand and the collar member 9 on the other hand automatically in a self-acting manner into the second position as shown by FIG. 1A. At its periphery the movable collar member 9 is provided with a fringe 18 which is formed as a generally U-shaped recess 15. The recess 15 is adapted to attach, by a screw threaded connection or otherwise, to an open end of the medicine or medication container 17. In this manner the dispenser 1 can replace a standard cap of a medicine container. To seal the contents of the medicine container 17 from the atmosphere, a sealing ring 19 is provided in the bottom of the U-shaped recess 15. On its inner side the movable collar member 9 is also sealed from the atmosphere by a typical O-ring 21 arranged on the outer circumference of the passage member 5. The medicine container 17 in FIG. 1A is seen to contain three shaped solid preparations 23, 25, 27, which each can be a solid pharmaceutical agent or solid substances in the form of for example a pill or a tablet. As shown in FIG. 1A the dispenser 1 is in its second—and at this stage inactive—position and/or situation.

Operation of the dispenser 1 will now be explained in reference to FIGS. 1B through FIG. 1F. In FIG. 1B the container 17, especially the medicine or medication container, is moved towards the bottom 7 of the housing 3 against the action of the coil spring 11 that is, that the housing 3 and the passage member 5 on the one hand and the collar member 9 on the other hand are moved relatively in respect to each other. This brings the receiving chamber 2 in communication with the interior of the medicine container 17 via the receiving opening 4 of the collar member 9. This is the first position of the housing 3 and the passage member 5 with the receiving chamber 2 being in receiving communication with the receiving opening 4 of the collar member 9. An end position of this first position is reached when an inner sleeve 9A of the movable collar member 9 abuts a step 5A of passage member 5. The receiving chamber 2 is dimensioned to only accommodate a single one of the shaped preparations 23, 25, 27 once the movable collar member 9 is in the first position. As shown in FIG. 1B the solid preparation in the form of a pill or tablet 25 has entered the receiving chamber 2. A passage or guiding passage 29 formed in the passage member 5 connects the receiving chamber 2 with the dispensing orifice 6 and has an exit 31 at the bottom 7 of the housing 3. Nonetheless it would be undesirable when the solid preparation 25 could yet pass towards the exit 31. If this were possible the solid preparations 23, 27 would also be able to exit from the guiding passage 29. To prevent this from happening, the guiding passage 29 has a restricted position 33 which is spaced closer to the inner sleeve 9A next to the side of the guiding passage 29 than the diameter or other relevant size, of the solid preparations 23, 25, 27. The guiding passage 29 is of smaller size than a solid preparation 23, 25, 27, so that they are prevented from entering the guiding passage 29. As shown in FIG. 1B the solid preparation 25 will prevent the next solid preparation 27 from entering the receiving chamber 2. FIG. 1C shows the dispenser 1 in an intermediate position of the movable collar member 9 and the housing 3 and the passage member 5, when moving back to its second position as shown by FIG. 1A. The inner sleeve 9A is still preventing the solid preparation 25 from passing the restricted portion 33 of or into the guiding passage 29. It is also seen that the collar member 9 is urging the solid preparations 23, 27 back into the container 17, past the passage member 5, because the receiving chamber 2 is more and more leaving its position of receiving communication with the receiving opening 4 and the top portion 8 or top area of the passage member 5 is going to close and shut the receiving opening 4.

FIG. 1D shows the collar member 9 fully and the housing 3 and the passage member 5 returned into their second position. The inner sleeve 9A of the collar member is now raised, with the assistance of spring 11, to a level sufficient to allow the solid preparation 25 to pass the restricted portion 33 of the guiding passage 29 to continue towards the exit opening 31 and then leave the housing 3 through the dispensing orifice 6. To enable this, an upstanding wall 35 of the housing 3 provides a complementary guiding passage part 22 arranged in the housing 3. In this second position of the collar member 9 and the receiving chamber 2 relative to each other is the receiving chamber 2 in dispensing communication with the dispensing orifice 6 of the housing 3. But, the receiving chamber 2 is not in receiving communication with the receiving opening 4 anymore. The exit and release and dispense of the solid preparation 25 is shown by further stages thereof in FIGS. 1E and 1F.

It is further indicated in FIGS. 1D-1F that the housing 3 on its interior is provided with the upstanding wall 35 which forms a boundary of the guiding passage 29 including the complementary guiding passage 22 opposite the restricted portion 33. The movable collar member 9 is provided with a depending wall 37 which can slide along the exterior of the upstanding wall 35, when the movable collar member 9 and the movable housing 3 and passage member 5 are moved into their first position as shown in FIG. 1B.

In the position of FIGS. 1D-F the upstanding and depending walls 35, 37 further define the guiding passage 29 comprising the complementary guiding passage part 22 and prevent the solid preparation 25 from getting trapped in the interior of the housing 3. From the position shown in FIG. 1F, the dispenser 1 is ready to deliver a next solid preparation 23, 27 from the container 17. Due to the construction comprising the upstanding wall 35 the guiding passage 29 is broadened and enlarged in this second position of the housing 3 and the passage member 5 and the collar member 9 to form a passage sized and dimensioned to let the solid preparation 25 pass and fall through in the direction to the exit opening 31 of the guiding passage 29. From this exit 31 the solid preparation 25 will fall through the dispensing orifice 6 and leave the dispenser 1. Thus, in this second position, the guiding passage 29 for connecting the receiving chamber 2 and the dispensing orifice 6 is in its position for bringing the receiving chamber 2 in dispensing communication with the dispensing orifice 6. The complete passage for enabling the solid preparation 25 to fall through is partly formed in the housing 3 by the complementary guiding passage 22 and partly formed by the guiding passage 29. This construction makes it possible to separate during each dispensing step one of a plurality of solid preparations 23, 25, 27 contained in the medicine or medication container 17 by bringing or delivering it into the receiving chamber 2. This happens by gravity when the passage member 5 is in its first position with the receiving chamber 2 being in receiving communication with the receiving opening 4. To support the falling in of a solid preparation into the receiving chamber 2, the surrounding of the receiving opening 4 is of a hopper-like configuration. On the other hand, to avoid that a solid preparation 25 received by the receiving chamber 2 immediately will leave the receiving chamber 2 into the guiding passage 29, the guiding passage 29 is of a smaller size than the average diameter or overall size of the pill like solid preparation 25 or the overall dimensions of such a solid preparation. Due to this feature the receiving chamber 2 has now to be moved along the inner sleeve 9A, which closes the entrance of the receiving chamber 2 until the passage member 5 reaches its second position wherein the receiving chamber 2 is in dispensing communication with the dispensing orifice 6 of the housing 3 via the guiding passage 29 and its extension in the housing, which is delimited by the upstanding wall 35 of the housing 3. Movement of the housing 3 and the passage member 5 on the one hand and the collar member 9 on the other hand relatively to each other is carried out in the longitudinal direction of the dispenser 1. Further, because there is a distance between the inner and rim portion 9B and the inner upper rim portion 35A of the upstanding wall 35 in vertical direction it is possible for a solid preparation 25 being in the receiving chamber 2 to fall out of the receiving chamber 2 by gravity as soon as the passage member 5 reaches its second position. To avoid that the respective solid preparation 25 enters deeper into the housing 3, the inner rim portion 37A of the depending wall 37 extends nearly to the point of the inner upper rim portion 35A of the upstanding wall, so that it is not possible for a solid preparation 23 to leave the guiding passage 29 for entering into other regions of the housing 3.

While it is important to ensure that certain pharmaceutical agents in the form of a shaped object are delivered in an amount of only one at a time, it may also be desirable to at least monitor the proper usage of such a medicament dispenser.

The shape and dimensions of the guiding passage 29 and the complementary guiding passage part 22 can be adapted to the shape and dimensions of the solid preparation, so as to provide for best dispensing results. The shape and dimensions of the passage member 5 and especially of the top area thereof can be adapted to the shape and dimensions of the respective solid preparation 23, 25, 27 to be dispensed. An advantageous shape of the top area of the passage member 5 is when the top area is bevelled off to one or two sides as shown by FIG. 1A-1F and 2. Such a shape helps to direct the solid preparation into the best position to enter the receiving chamber 2 and can thus be regarded as a positioning means. It is within the skills of the man skilled in the art to determine what shape and dimensions are necessary for what form of solid preparation and can be easily determined without undue burden.

To build a closure for the receiving opening 4 it is advantageous to have the passage member 5 arranged centrally in the housing and in such a manner that it, especially its top area 8, closes at least the bottom area of the receiving opening 4 in respect to finish receiving further communication with the receiving chamber 2, when the passage member 5 reaches its second position.

The area 8 at the top of passage member 5 that can be in contact with the solid preparations 23, 25, 27 to be dispensed can be made out of the same material as the rest of passage member 5 or it can fully or partially be made out of a different material. When the top area of passage member 5 is made out of a different material this opens the possibility to adjust the characteristics of the material to the properties of the solid preparation 23, 25, 27. This is very advantageous when for example the solid preparation has a low strength (hardness) and is thus vulnerable to deformation or even destruction of its integrity. In such a case the top area of passage member 5 can for example be made out of a relatively soft material so as to prevent crushing of the solid preparation. With “relatively soft” is meant a material that is softer than the material the passage member is made of.

It is even possible to make use of a removable top area 8 of passage member 5. By using such a removable top it is possible to use the dispenser several times with various solid preparations by using different types of top areas 8 so as to be able to adjust it to the dispensing of solid preparations with various properties, such as for example the hardness, or shapes.

Instead of or in addition to, adjusting the choice of material of the top area 8 of the passage member 5 to the properties of the solid preparation 23, 25, 27, it is also possible to adjust the choice of material for the movable collar member 9 to the properties of the solid preparation. The movable collar member 9 can then fully or partially be made out of a softer material. Partially made out of includes the possibility to coat a movable collar member 9 with a layer of relatively soft material.

Suitable examples of such relatively soft materials for use in the construction of passage member 5 or movable collar member 9 are materials with a Shore A hardness of maximally 60, preferably less than 50, more preferably less than 35. Suitable materials are for example natural and/or synthetic rubbers, elastomers, thermoplastic elastomers, vinyl-based polymers and/or plastomers, such as for example TPV, TPO, EP(D)M, SEBS, SBS, PE, copolymers of PP and PE. Other suitable materials are for example nylon, polyurethane and/or Teflon. Foams of materials with a suitable Shore A hardness are also suitable. Also compounds and/or blends of suitable types of materials are an option. The man skilled in the art can easily determine which material is most suitable for use with a specific solid preparation.

Depending on the kind of solid preparation to be dispensed, it can be advantageous to use only materials that are approved for use in contact with food and/or pharmaceuticals, such as for example FDA-approved materials.

FIG. 2 shows an embodiment of a dispenser 101 similar to that of FIGS. 1A-1F but additionally provided with therapy compliance means in the form of electronic monitoring and communication means. The monitoring means includes laser detector 41 which detects the passage of a solid preparation 25 through the guiding passage 29 when it exits from the exit opening 31. The laser detector 41 is, advantageously, an LED (light emitting diode) which emits light within the IR-frequency range, so that accidental triggering by ambient light can be prevented. Further the dispenser 101 is provided with an electronic circuit 43 which is in the form of a printed circuit board and includes an antenna for external communication. An energy supply means to supply the necessary energy for the laser detector 41 and the electronic circuit 43 is provided in the form of a battery 45. It is further advantageous for battery life, when the laser detector 41 and its related circuitry is kept in a sleeping mode until the dispenser is actuated by a user.

In further reference to FIGS. 3A and 3B an alternative embodiment of a dispenser 201 will be briefly described. Similar components are referenced by reference numerals similar to those used in FIGS. 1A-F and 2, but for the addition of “200”. FIG. 3A shows the dispenser 201 in a position comparable to FIG. 1B, and FIG. 3B shows a position comparable to FIG. 1F. The dispenser 201 has a housing 203 having a bottom 207 and a passage member 205. Slideable within the housing 203 is a movable collar member 209, which is adapted to be connected to a medicine container 217. So relative movement between the housing 203 on one hand and the passage member 205 and the collar member 209 on the other hand is possible. Slideably arranged in a central aperture or receiving opening 204 of the movable collar 209 is the passage member 205 having an object or solid preparation receiving chamber 202. While, similar to the embodiments of FIGS. 1A-F and 2, the movable collar member 209 may be biased into an inactive position, the before-mentioned second position, by a resilient spring, for clarity such a spring is not represented in FIGS. 3A and 3B. The housing 203 has a dispensing orifice 206 on its side. In the position shown in FIG. 3A one shaped solid preparation 225 of a plurality of solid preparations 223, 225, 227 can enter the receiving chamber 202 of the passage member 205. After the movable collar member 209 and the container 217 have been allowed to return to an initial position as shown in FIG. 3B, wherein the housing 203 and the passage member 205 are in their second position relative to the collar member 209, the passage member 205, which was resting on a guiding member 229 will be raised by the collar member 209 having moved upwardly. The enlarged head portion 208 abuts the central aperture or receiving opening 204. Hence the passage member 205 has a position with respect to the movable collar member 209, as illustrated in FIG. 3A, in which its receiving chamber 202 is open to an upper side of the movable collar member 209. As shown in FIG. 3B the passage member 205 also has a second position, with respect to the collar 209, in which the receiving chamber 202 opens to a lower side of the movable collar 209 and the housing 203. As apparent from FIG. 3B the solid preparation 225, can then escape from the chamber 202 and, guided by a ramp surface on the guiding member 229, escape through the dispensing orifice 206 in the side of the dispenser device 210. As with the embodiment of FIG. 2, also the variant of FIGS. 3A and 3B may be provided with electronic means for monitoring, controlling, indicating and communication, especially data communication.

In the embodiment according to FIG. 3A and FIG. 3B the housing 203 and the passage member 205 are not in a one part form and are not jointly connected to each other. In this embodiment, starting from a position as shown by FIG. 3B the container 217 together with the collar member 209 is moved relatively to the housing 203 in the direction of the arrow 211. During this movement inner portion or inner surface 212 of the passage member 205 comes into a resting contact with the upper surface 214 of the guiding member 229. By coming into this resting contact the passage member 205 stops the common movement together with the collar member 209, so that now the collar member 209 continues to move in the direction of the arrow 211 but now with a relative movement in respect to both the housing 203 and the passage member 205. When the collar member 209 reaches the position as shown by FIG. 3A further relative movement is stopped due to an inner sleeve 209A that comes into contact with the bottom 207. The housing 203 and the passage member 205 are now in the first position with the receiving chamber 202 being in receiving communication with the receiving opening 204. To allow this the passage member 205 is of such a height that the opening of the receiving chamber 202 opens into the hopper-like shaped receiving opening 204. Afterwards, urged by the force of a not shown spring, the collar member 209 is moved back into its position as shown in FIG. 3B whereby the passage member 205 is also moved into this position.

Another embodiment is shown by FIGS. 4A-4C, wherein similar components if not referred to in detail are referenced by reference numerals similar to those already used before but for the addition of “300”. FIG. 4A shows the starting position of a container 317, containing solid preparations 225, 227, which container is provided with a dispenser 301 to build a dispensing device 310. The collar member 309 is mounted on the dispensing orifice of the container 317 with its receiving part 314 extending in the region of the dispensing orifice of the container 317. This receiving part 314 comprises a funnel-like shaped receiving opening 304, which is closed at its bottom side and at its inner side. It is delimited and obstructed by a passage member 305 extending longitudinal within the housing 303 and being fixed with the housing 303. The funnel-like shaped receiving opening 304 is filled with two solid preparations 225, 227. Starting form this position, which is the same as the position as shown in FIG. 4C and which is the second position wherein the housing 303 and the passage member 305 are in a position with the receiving chamber 302 being in dispensing communication with a dispensing orifice 306 of the housing 303, the collar member 309 on one hand and the housing 303 and the passage member 305 on the other hand are moved relatively to each other until the position as shown in FIG. 4B is reached. In this position the receiving chamber 302 is now in receiving communication with the receiving opening 304 so that one single solid preparation 325 enters the receiving chamber 302. Because the receiving chamber 302 has a dimension, which allows to receive and contain only one unit dose of a solid preparation, the remaining solid preparation 227 remains in the receiving opening 4. From this position the collar member 309 and the housing 303 together with the passage member 305 are moved back into the first position as shown by FIG. 4C where now the receiving chamber 302 is in receiving communication with the dispensing orifice 306 via a guiding passage 329, which is formed within the housing 303. Therefore, the solid preparation 325 leaves the housing 303 by gravity, whereas the remaining solid preparation 227 is together with the collar member 309 moved back into the starting position, where the receiving opening 304 is separated from the receiving chamber 302.

In FIGS. 4A-4C it can also be seen that the dispenser 301 is provided with an electronic circuit 343 and a laser detector or a LED 341 for detecting the dispensing of a unit dose of a solid preparation 225. Also it can be seen where the spring 311 is positioned within the housing 303 and partly within the collar member 309 as well as in its tensed position (FIG. 4B) as in its expanded position (FIGS. 4A and 4C).

A further embodiment is shown by FIGS. 5A-5C, wherein similar components if not referred to in detail are referenced by reference numerals similar to those already used before but for addition of “400”. In this embodiment the collar member 409 together with the passage member 405 is relatively movable in respect to a housing 403. In this embodiment, the funnel-like shaped receiving opening 404 is in its starting position for communicating with the receiving chamber 402 of a passage member 405 so that a solid preparation 225 can enter into the receiving chamber 402. The bottom of the receiving opening 404 is constituting by a ramp-like formed part 416 of the housing 403. The dispensing orifice 406 of the housing 403 is closed by a closure part 418 of the passage member 405. Starting from the position as shown by FIG. 5A, the elements of collar member 409 and passage member 405 on one hand and the housing 403 on the other hand are relatively moved in respect to each other until the relative position as shown in FIG. 5B is reached. In this position the receiving chamber 402 is now in dispensing communication with the dispensing orifice 406 of the housing 403 via a guiding passage 429, so that the solid preparation 225 is dispensed out of the receiving chamber 402. Form this position the collar member 409, the passage member 405 and the housing 403 are moved back into the position as shown by FIG. 5C where the receiving chamber 402 is in receiving communication with the receiving opening 404 of the collar member 409 again. The dispenser 401 according to this embodiment is also provided with an electronic circuit 443 and a laser detector 441 and a spring 411 as shown in FIGS. 5A-5C.

The embodiment according to FIGS. 5A-5C is of a air tight and moisture tight construction wherein the air tightness and moisture tightness is achieved by ring shaped elements 430 and 432, wherein the ring shaped element 430 of the collar member 409 is extending outwardly and the ring shaped member 432 of the housing 403 is extending inwardly. Both elements 430, 432 are laying together and forming an air tight closing. Likewise, circular arranged elements 436 of the housing 403 and 434 of the passage member 405 form a air tight seal at the bottom of the housing that all possible ways of entrance for humidity or air to come into the housing 403 and from there into the container 417 are closed by an air tight seal. Also, the inner side of the U-shaped recess 415 is build in an air tight manner by an insertion 438, which seals the portion, where the tread of the container is screwed with the insertion 438 to form a close and attached connection with the collar member 409. The insertion 438 is also provided with circular sealing members 440 for sealing the insertion 438 against the inner surface of a surrounding wall of the collar member 409.

From FIGS. 6A and 6B wherein similar components if not referred to in detail are referenced by reference numerals similar to those already used before but for addition of “500”, it can be taken that the housing 503 of a dispenser 501 being part of a dispenser device 510 comprises flexible elements 520, which may be pushed inwardly to bring flexible elements 522 of the collar member 509 out of their blocking contact with blocking elements 524 provided inside the housing 503. When pushing the flexible elements 520 the elements 522 are moved to come free from the blocking elements 524 so that relative axial movement between the housing 503 and the collar member 509 with the passage member 505 is possible to reach the dispensing position as shown by FIG. 6B. At its bottom side, the housing 503 is provided with a releasable and detachable cap 526, which is equipped with an electronic circuit 543, and energy supply means 545 and laser detectors 541, which can also be seen from the FIG. 7.

A further embodiment of the invention is explained in respect to FIGS. 8A-8C. This embodiment is similar to that according to FIGS. 5A-5C and realises the same dispensing mechanism as the embodiment according to FIGS. 4A-4C. For dispensing again the collar member 609 is moved in respect to the housing 603 and the passage member 605 into a first position with the receiving chamber 602 being in receiving communication with the funnel-like shaped receiving opening 604 of the collar member 609 and into a second position with the receiving chamber 602 being in dispensing communication with the dispensing orifice 606 of the housing 603, where again the receiving member 602 is not in receiving communication with the receiving opening 604 anymore. The difference consists in a locking element 650, which interacts with the collar member 609, a separating element 652 connected to the passage member 605 and extending into the receiving opening 604 and a closure cap 654 provided at the bottom of the housing 603. The locking element 650 comprises a sleeve-like member, which is placed on the top of the container 617 surrounding the dispensing orifice of the container 617. As can be seen from the FIGS. 9 and 10 the locking element 650 comprises two flexible elements 656, which in the attached position of the element 650 and the collar member 609 interact with stopping faces 658 provided at the inner wall of the collar member 609. During this blocking interaction it is not possible to unscrew the dispenser 601 from the container or medicine bottle 617. To open the dispensing orifice of the container 617 the elements 656 have to be pushed to come free from the blocking surfaces 658, so that it is then possible to unscrew the dispenser from the container 617.

The separating element 652 comprises bar-like elements 660 provided on its surface, which are helpful for separating solid preparations containing the container 617 so that only one above the other enters the dispensing opening 604. The bar-like element 660 may also be provided with brushes, which improve the separating effect.

Another feature is the closure cap 654, which is rotatable for some degrees in circumferential direction mounted outside at the bottom of the housing 603. It can be see from FIG. 11, that this closure cap 654 is provided with the dispensing orifice 606 of the housing. Further the closure cap 654 comprises a resilient member 662, which interacts with the bottom 607 and urges the closure cap 654 at its position attached to the bottom 607 of the housing 603 into a position where the bottom 663 of the cap 654 faces the exit opening 631 of the guiding passage 629, so that a solid preparation can not be dispensed although it is already placed in the guiding passage 629. For dispensing such a solid preparation 225, it is necessary to turn and rotate the closure cap 662 for some degrees against the force of the resilient member 662 until the dispensing orifice 606 comes in an aligned position with the exit opening 631. In this position now the solid preparation 225 will fall out by gravity and be dispensed.

Within the housing 603 there again are arranged an electronic circuit 643 and a laser detector or detecting sensor 641 and although not shown an energy supply means and other electronic elements to be used for monitoring, controlling, indicating and/or communication with elements outside the dispenser 601 or the dispenser system 610. For arranging the electronic elements, there might be a compartment 666 provided at the bottom side of the passage member 605.

Alternatively, in respect to the rotatable arranged closure cap 654 it is also possible to have a sliding or closing flap closing the dispensing orifice of a housing 3, 203, 303,403, 503, 603 which has to be opened for dispensing a solid preparation 225.

All the embodiments as disclosed above may comprise humidity and/or moisture and/or temperature detecting sensors, although not mentioned in detail. Especially the respective container 17, 217, 317, 417, 517, 617 is equipped with an electronic temperature sensor 25, 38 and/or an electronic humidity sensor 25, 36 as referred to below.

Although not mentioned before also the dispensers 301, 401, 501 and 601 are provided with an upstanding wall 335, 435, 535 and 635, wherein the dispensers 401, 501 and 601 likewise comprise a depending wall 437, 537 and 637 respectively and wherein all the dispensers are provided with an inner sleeve 309A, 409A and 609A. In respect to the inner sleeve 609A this inner sleeve 609A also constitutes a stopper element which stops further relative movement between the collar member 609 and the passage member 605 as soon as the first position of the receiving chamber 602 being in receiving communication with the receiving opening 604 is reached. For this purpose—as can be seen from FIG. 8B—the inner sleeve 609A abuts upon a rim portion 616 provided at the lower part of the opening of the receiving chamber 602.

Also for providing a guiding means the collar member 609 and the housing 603 are provided with guiding means 628, 630, wherein the guiding means 630 also extends into the closure cap 654 where it is referenced by reference number 632.

FIG. 12 shows a block diagram of the electronic circuit 2500 for use in monitoring and controlling administration of medications and for communication. The electronic circuit 2500 includes a processor 2502, which may, for example, be an 8-bit microcontroller, such as a P89LPC936, developed by Philips and available from NXP Semiconductors Netherlands B.V. Of course, it will be understood that other processors or microcontrollers may also be used in the electronic circuit 2500. In some embodiments, the processor 2502 may be clocked by an external clock or crystal 2503.

The processor 2502 may include a memory 2504, for storing programmed instructions for the processor 2502 and/or data used by the electronic circuit 2500. Alternatively, the memory 2504 may include one or more external memory devices (not shown). The memory 2504 may include non-volatile memory, such as flash memory, EEPROM memory, or static memory, and/or volatile memory, such as DRAM.

The electronic circuit 2500 is powered by a battery 2506, which may have its electrical characteristics adapted to the needs of the electronic circuit 2500 by a power regulator 2508. The battery 2506 may be a conventional replaceable battery, or a rechargeable battery, which may be recharged, for example, when the device is connected to a docking station (see below). The power regulator 2508 may also include the ability to detect the status of the battery 2506, and provide the status information to the processor 2502. In some embodiments, an additional battery measuring device (not shown) may be used to measure the status of the battery 2506.

The processor 2502 communicates with a first transceiver 2510, which communicates wirelessly with other electronic devices via a first antenna 2512. The first transceiver 2510 uses radio frequency (RF)-based communication, such as Near Field Communication (NFC) or other wireless communication technologies suitable for short-range and/or low-power wireless communication, such as other RFID technologies, Bluetooth, or ZigBee. Where power considerations permit longer range communications, other wireless communications technologies, such as Wi-Fi, WiMAX, or various cellular technologies may be employed.

In some embodiments, where the device includes an optional display 2514, the processor 2502 may further include a display driver 2516, to operate the display 2514. In some embodiments, the display driver 2516 may be implemented at least in part as driver software. In some embodiments, the display driver 2516 may be a separate device (not shown), rather than being included in the processor 2502.

As discussed above, an optical detector 2518, such as a laser detector, an LED and detector, an infrared LED and detector, or other opto-electronic detection device, is used to determine when a solid preparation, such as a pill, has been dispensed by the device. A signal from the optical detector 2518 is provided to the processor 2502 for evaluation. In some embodiments, where there are multiple optical detectors (not shown), such as where there are multiple dispensing paths for pills, in which case one such detector may be present in each such path, signals from each of these the optical detectors are provided to the processor 2502.

The electronic circuit 2500 may also include numerous control switches for adjusting the settings of the processor 2502 and/or of the electronic circuit 2500. For example, a first switch 2520 can be used to activate or deactivate the electronic monitoring and communication. A second switch 2522 can be used to detect tampering with the dispenser device by detection its removal from the container. Third and fourth switches 2524 and 2526 may be used, for example, for setting the time in hours (third switch 2524) and minutes (fourth switch 2526). A fifth switch 2528 may be used to select use of an audible alarm, such as a buzzer 2530, which may be sounded when, for example, a patient has forgotten to dispense a medication at the time that he is supposed to take it, or when temperature and/or humidity sensors indicate that the medication is being improperly stored. It will be understood that, depending on the user interface needs of the embodiment, the control switches may be assigned to other functions.

The electronic circuit 2500 may also optionally include alarm devices, such as the buzzer 2530 and/or a vibration device 2532. These alarm devices may be activated by the processor 2502 separately or in unison, to alert a user to a variety of conditions. In some embodiments, the buzzer 2530 may be controlled to produce a variety of different sounds to alert a user to various conditions. For example, one sound may be used to warn the user that he should take a dose of a medication, another sound may be used to warn the user that he is attempting to dispense additional medication before it is safe to take another dose, a further sound may be used to warn the user that the medication in the container is running low, another sound may be used to indicate that the battery is low, and still another sound may be used to indicate to the user that temperature and/or humidity sensors are indicating that the medication is not being properly stored. In some embodiments, the buzzer 2530 may be a small speaker, capable of producing sounds including buzzing noises, speech, musical tones, or other sounds, depending on the message to be conveyed to the user.

The timing of the sounds or vibrations produced by the buzzer 2530 and/or vibration device 2532 may be controlled by the processor 2502 to convey particular meanings or warnings. For example, the processor 2502 may be programmed to use the buzzer 2530 to produce a warning sound at a predetermined time after the solid preparation should have been dispensed. For example, a short beep could be generated every minute during one hour following the time when the solid preparation should have been dispensed. The processor 2502 may be programmed to cease such warnings when the solid preparation has been dispensed through the dispenser.

The processor 2502 may be programmed to use the vibration device 2532 in a similar manner. For example, the vibration device 2532 may be switched on for one second at the time that the solid preparation should be dispensed. This may be repeated, for example, sixty minutes later, if the solid preparation is not dispensed.

In some embodiments, the electronic circuit 2500 may optionally be connected to a blocking mechanism 2534. When activated, the blocking mechanism 2534 prevents the dispenser from dispensing a solid preparation. This can be achieved, for example, by sending electrical signals to a motor or solenoid to move a stopper notch between a locked and an unlocked position, as described above. The blocking mechanism 2534 may be used, for example, to prevent a user from dispensing a further dose of a medication during a time period over which a further dose is not needed or could be dangerous, or from dispensing medication which may have been damage by exposure to temperatures or humidity levels outside of an acceptable range.

In some embodiments, the electronic circuit 2500 may further include additional sensors, such as an optional humidity sensor 2536 and/or an optional temperature sensor 2538, positioned in such a way that they are able to detect the humidity and/or temperature of the pills, capsules, or other solid preparations stored in the dispenser device. The humidity sensor 2536 may, for example, be a capacitive humidity sensor, a resistive humidity sensor, a thermal conductivity humidity sensor, or other suitably small, commercially available electronic humidity detection device. Similarly, the temperature sensor 2538 may be a thermistor or other resistance temperature detector, or any other suitably small, commercially available electronic temperature detector. These sensors should be positioned so that they measure the temperature and/or humidity of the pills, capsules, or other solid preparations stored in the container, bottle, or dispenser.

Generally, the electronic circuit 2500 may be configured to fit within a portion of the dispenser mechanism, as shown in earlier figures above. Individual components of the electronic circuit 2500 may be built into other portions of the dispenser, depending on their function. For example, the humidity detector 2536 and temperature detector 2538 may be positioned so that they measure the humidity and/or temperature in the locations where pills, capsules, or other solid preparations are stored.

In addition to the features described above, the dispenser mechanism may include an identity detection device (not shown). Such an identity detection device may be connected to the electronic circuit 2500 to permit the user of the dispenser to be identified. An example of such an identity detection device is a fingerprint reader and identifier. The processor 2502 may be programmed to accept signals from such a fingerprint reader (not shown), and to activate the dispenser only when the fingerprint read by the fingerprint reader matches a stored fingerprint. The stored fingerprint may be stored in the memory 2504, or in a memory associated with the fingerprint reader (not shown). Since fingerprints are unique, the fingerprint of the authorized user of the device may be stored, so that only the authorized user of the device is able to activate the dispenser and to dispense a solid preparation. Other identity detection devices could also be used, including other (preferably small/portable) biometric devices, or security measures such as requiring the user to enter a combination or a personal identification number (PIN).

By adding such an identity detection device to the electronic circuit 2500, an identity function may be implemented for the dispenser. This identity function makes it possible that only an authorized or intended user, such as the patient or a caregiver, can activate the dispenser. Using this feature, the solid preparation could not be dispensed, for example, by a child who finds the device. Additionally, the identity function may reduce the risk of taking the wrong medication, for example if there are several such dispensers being used by different people in a single household.

Further, the electronic circuit 2500 may be connected to an RFID reader (not shown) in the dispenser. Some medication containers (not shown) may be equipped with RFID chips (not shown) that can contain information on the medication in the container. Such RFID chips may be placed on or built into the container when the container is manufactured, or at a later time, such as when a pharmacist provides the container containing medication to the patient. The RFID chip in such a container may be a standard MIFARE RFID chip, or any other type of RFID chip or tag. A drug manufacturer, physician, and/or pharmacist may store information on the RFID chip. For example, the RFID chip may include the date and time of packing a medication in the container, the content of the container, the drug type and number of pills, the expiration date of the medication, a unique identification number, patient medication intake times, length of the course of treatment, pharmacist license number, prescribing physician license number, proper storage temperature and humidity ranges, and/or other information pertaining to the solid preparation contained in the container.

The RFID reader may be used to read this information from the RFID chip attached to the container when the dispenser is attached to the container. The information can then optionally be stored in the memory 2504, and used by the processor 2502 for a variety of purposes. For example, if the dispenser includes a display, such as the display 2514, the information read by the RFID reader may be displayed. This can reduce the risk of taking the wrong medication or medication that has passed its “use by” date. The risk of taking the wrong medication may be especially pronounced when a patient needs to take two or more types of medication. When an RFID reader in the dispenser is used with an RFID chip on the container, the patient is able to read on the display which of his medications is contained in the container. This may be particularly useful when the labelling of the container has faded, for example due to frequent use or contact with water or solvents. The processor 2502 may use the information read from an RFID chip on the container for purposes such as displaying the drug contained in the container, determining when the container is almost empty (based on pill count), automatically programming the times that the solid preparation should be dispensed or accessed so that the processor 2502 may generate alarms at the proper times, producing a warning when a medication has expired or has been stored at an unacceptable temperature and/or humidity level, preventing a user from dispensing or accessing the solid preparation at the wrong times, after it has expired, after a course of treatment has been completed, if improper temperature and/or humidity conditions may have affected the medication, and other uses for such information.

Additionally, in some embodiments, the RFID reader may also store information back into the RFID chip on the container. This means that compliance information may be available in the container chip when it is returned to the pharmacist, for example for a refill.

Referring now to FIG. 13, a system 2600 for communicating with a dispenser 2601 is described. A docking station 2602 is used for electronic data communication and electronic data transfer between the dispenser and a computer (not shown) or other communication device (not shown). Additionally, in some embodiments, the docking station 2602 may be used to recharge a rechargeable battery in the dispenser.

In some embodiments, the docking station 2602 may include a wired connection 2604, such as a USB connection or other wired connection for transferring data between the docking station 2602 and a computer or other communication device. In some embodiments, the docking station 2602 may include a wireless communication device (not shown) to allow the docking station 2602 to communicate via a wireless connection, such as through a cellular network, a wireless wide area network, or a wireless local area network. The docking station may be powered using an AC mains adapter 2606, or through power received over the wired connection 2604.

The docking station 2602 is also equipped with an electronic reader-writer device (described below), for reading and writing data from the dispenser. In some embodiments, where the dispenser is able to communicate directly with a wide area network or cellular network, or where the communication is handled by a portable reader, such as a mobile phone equipped with an NFC reader, the docking station 2602 may not be needed for the dispenser to communicate its data.

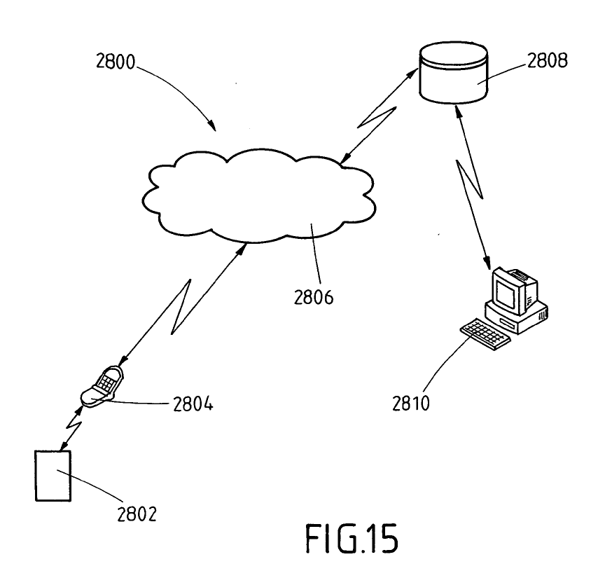

FIG. 14 shows a block diagram of an electronic reader-writer device 2700 suitable for use in the docking station 2602 of FIG. 26. The reader-writer device 2700 includes a second transceiver 2702 with a second antenna 2704 for communicating with the first transceiver 2510 in the dispenser, as shown in FIG. 12. When used with the reader-writer device 2700 in a docking station, the dispenser may preferably use a low power, short range communication technology, such as Near Field Communication (NFC), Bluetooth, or ZigBee. Other communications technologies suitable for longer range wireless communications may also be used, such as WiFi or other wireless local area network (WLAN) technology. Of course, the communication technology used by the reader-writer should be compatible with the communication technology used by the dispenser. Alternatively, a physical electrical connection between the dispenser and the docking station could be used, assuming that the dispenser includes an appropriate interface. For example, if the dispenser has a USB interface, it may be possible to connect it to the docking station (or directly to a USB-equipped external computer) using the USB interface. A physical interface, such as a USB interface, may also be useful for charging a rechargeable battery in the dispenser.

The reader-writer device 2700 also may include a wired connection interface 2706. The wired connection interface 2706 may be, for example, a USB interface through which the reader-writer device connects the docking station to an external computer system. Other types of wired connections, such as a serial connection or a wired Ethernet connection could also be used.

The reader-writer device 2700 may be powered from an AC adapter (not shown) through a voltage regulator 2708. Alternatively power may be received from other sources, such as through the wired connection interface 2706.

Once the data are transferred from the dispenser to an external computer (through a docking station, such as the docking station 2602, shown in FIG. 13, when the dispenser is unable to communicate directly with the external computer), the external computer can transfer the data to a remote computer via a wide area network, such as the Internet. The dispenser may also receive data via a wide area network through an external computer (and, possibly a docking station). Further, programming or instructions for the electronic circuit 2500 of the dispenser, as shown in FIG. 12, may be sent from a computer at a remote location, and communicated to the dispenser via the Internet or other wide area network. The remote computer may, for example, be accessible by a physician, pharmacist, or other medical professional who is overseeing the therapy compliance of the patient who is using the dispenser. It will be understood that in some embodiments, where the dispenser includes wide-area networking or cellular communication capabilities, the dispenser may be able to connect to the Internet and/or the remote computer system without using an external computer or docking station to establish the connection. It will also be understood that in some embodiments, a mobile device, such as an NFC-equipped mobile telephone may be used to communicate between the remote computer and the dispenser.

Such a system is shown in FIG. 15. The system 2800 of FIG. 15 includes one or more dispensers 2802, which include the electronic circuitry 2500 as shown in FIG. 12. For purposes of illustration, these dispensers include NFC communication circuitry, which allows them to transfer data between a dispenser 2802 and an NFC-equipped mobile telephone 2804. The NFC-equipped telephone 2804 can wirelessly communicate via a wide area network 2806, such as a cellular communication network or the Internet with a remote database 2808, which collects and stores information from the dispenser(s) 2802. The remote database 2808 can be accessed (through the wide area network 2806 or a different wide area network) by a remote computer 2810, which may also remotely send instructions to the dispenser(s) 2802 through the wide area network 2806 and the mobile telephone 2804.

It will be understood that the communication path may be somewhat different, depending on the technology used. For example, if no NFC-equipped mobile phone is available, the dispenser may use a docking station (not shown) connected to a computer (not shown) to communicate with the remote database 2808 and/or the remote computer 2810. Alternatively, in some embodiments, the dispenser may be able to directly connect to the wide area network, and communicate with the remote database 2808 and/or the remote computer 2810 without using an NFC-equipped mobile telephone or a docking station.

As can be seen in FIG. 15, the therapy compliance monitoring and communication means provided can be mobile. The dispenser 2802 is arranged for monitoring the therapy compliance of a patient, and for remotely allowing or disabling the dispensing of a solid preparation, to help ensure therapy compliance. Wired and/or wireless communications can be used to report therapy compliance to the remote computer 2810, which may be used by a physician, pharmacist, or other medical caregivers to monitor compliance. Additionally, administration of therapy may be controlled or adjusted from the remote computer 2810, depending on the therapy compliance reporting received. Further, as can be seen, in addition to the Internet, other communication technologies may be used in the remote surveillance and control of therapy compliance, including mobile platforms, such as the mobile telephone 2804, and the like.

When a container with a solid preparation is issued by a pharmacist, the dispenser 2802 according to an embodiment of the invention is put in place on the container, such that solid preparations may be taken from the container by pushing a button on the dispenser 2802. The dispenser 2802 has a built-in clock/calendar so that when the button is operated and a solid preparation, such as a pill or tablet is dispensed, the date and time of this event are stored in a memory in the dispenser 2802. Similarly, the times of other events, such as recording of temperature and or humidity readings can be stored. The dispenser 2802 may optionally be programmed so that the solid preparation may only be dispensed at pre-programmed times, depending on the medication prescribed, and the instructions of the physician and/or pharmacist. This may prevent a patient from taking too many doses, since the dispenser 2802 is blocked after a dosage is taken, and will only dispense a further dose when the next dosage should be taken. It should also be noted that this option of programming the dispenser provides the opportunity to register and regulate a combination therapy, whereby more than one type of medication must be taken, as will be described in greater detail below.

Next, the date and time stamp at which a dose was dispensed, and/or other information, such as temperature and/or humidity data are transferred over the wide area network, which may be a mobile telephone network, such as GSM or GPRS, to the patient's record in the remote database 2808. As shown in the figure, in some embodiments, this transfer may be accomplished by reading the data from the dispenser using a Near Field Communication (NFC) mobile phone 2804, or by using another gateway for conversion of data from NFC or Bluetooth devices into SMS and GPRS data. It will be understood that other communication options, as described above are also possible. In some embodiments, other data collected by the dispenser may also be transferred along with the compliance data. For example, data concerning the temperature and humidity of the stored medication may be transferred. These data may indicate whether the pills, capsules, or other solid preparations are being stored in appropriate conditions. This information may be used to send the patient and/or the pharmacist or physician a warning if the medication is being stored at an inappropriate temperature or humidity. This data could also be used, for example, to dynamically adjust the expiration date of a medication, depending on its storage conditions, or to prevent a patient from taking medications which could become dangerous if stored for a period of time in an inappropriate manner. Other information, such as the battery status may also be transferred. This data may, for example, be used to warn the patient or pharmacist if a non-rechargeable battery in the dispenser device will need to be replaced.

The patient record in the database 2808 contains various kinds of patient information, including the therapy compliance records for the patient received from one or more dispensers. This information can be securely accessed by physicians, pharmacists, or other authorized medical caregivers from a remote computer 2810 over a wide area network, such as the Internet. The compliance data may be correlated and analyzed in the remote database 2808 or on the remote computer 2810, and if mal-compliance or non-compliance are detected, the patient can be warned, for example via an SMS service or the like. In some embodiments, when non-compliance or mal-compliance are detected, a call centre, pharmacist, and/or care organization may receive an instruction to call the patient to discuss his mal- or non-compliance.

A dispenser according to an embodiment of the invention can also communicate with another dispenser, either directly, through a docking station, or through a network. An advantage of such a dispenser is that it is possible to regulate an order in which two or more medications are taken. For example, in AIDS treatment, a combination of drugs may be prescribed, which need to be taken in a strict order and according to a strict time schedule. For example, the prescription schedule can specify that a first medication should be taken first, followed within one hour by a second medication. If the patient forgets that he has already taken the required dosage of the first medication, he may try to “correct” this by taking another dose of the first medication. Such non-compliance can have serious effects on the health of the patient and on the effectiveness of the treatment.

By communicating with each other, the dispensers according to an embodiment of the invention can reduce this problem. Using the above-described example, a first dispenser for a container containing the first medication can block further dispensing of the first medication until it receives a communication indicating that a second dispenser for a container containing the second medication has dispensed a dose of the second medication. Thus, a new dose of the first medication can only be taken after the required dose of the second medication has been taken. The time for taking the second medication can be set by the second dispenser receiving a communication indicating that the first medication has been dispensed by the first dispenser, causing the second dispenser to set a buzzer or other alarm feature to provide a warning one hour later that the second medication should be taken. By use of dispensers that are able to communicate with each other, according to an embodiment of the invention, a strict medication regime can be followed with reduced effort by the patient and with an increased rate of compliance.

It should be noted that in accordance with various embodiments of the invention, communication between the dispensers can be achieved directly between the dispensers, or via an indirect method. For example, the dispensers may communicate through a base station, or through a wireless network. Also, the dispensers could communicate indirectly through a database, such as the remote database 2808 shown in FIG. 15, or through another computer or communication device that receives and sends communications to dispensers in accordance with various embodiments of the invention.

The dispenser according to the invention can be used for dispensing various sizes and shapes of solid preparations. This feature makes it possible to use the dispenser several times for different solid preparations.

The dispenser according to the invention can be used in combination with any type of container. With container is here and hereinafter meant a reservoir for the solid preparations to be dispensed through the dispenser. Preferably the container has such dimensions that it can be carried by a patient. The combination of the dispenser with the container will be referred to as a device for dispensing solid preparations, or shortly a dispenser “device”. The present invention also relates to the device comprising the dispenser and a container. The combination of the dispenser with included an electronic circuit and energy supply will be referred to as “dispenser system”. The combination of dispenser system with a docking station will be referred to as “system”.

The container that is used in combination with the dispenser according to the invention is not particularly critical and the characteristics will mostly depend on the contents of the container. For example when the contents of the container are susceptible for (day)light, the container can be opaque or made not transparent. The shape of the container can take any desirable form, but will generally be a cylinder. The size of such a cylinder will generally be determined by the size of the solid preparations and the number of preparations that the container should hold. For pharmaceutical solid preparations generally bottle sizes of 30-250 cc are used.

It is advantageous that the dispenser according to the present invention can be combined with a standard medication container, such as, for example, those which are currently in use in the USA by pharmacies and/or pharmaceutical companies to distribute pharmaceutical preparations to patients. For this purpose, the U-shaped recess 15, 415 and the thread arranged therein are of a standard size to match standard containers. The generally known and widely used containers have a screw cap which can be removed and replaced by the dispenser according to the invention. Therefore it is not necessary to repack the solid preparations from the standard medical container wherein the solid preparations are supplied, to a different container. This reduces the risks in contamination and mistakes during repacking. The dispenser according to the present invention in combination with a standard container supplies to the relevant user the advantages as described above.

The dispenser 1, 201, 301, 401, 501, 601 according to the present invention for dispensing solid preparations can include a housing having a bottom, a movable collar or collar member, movable relative to the housing between a first position and a second position, a passage or guiding passage defined in the housing leading to an exit opening or dispensing orifice of the housing, and a passage member adapted to accommodate a solid preparation, which passage member is relatively movable with respect to the movable collar. In this dispenser the movable collar can be biased into the first position by resilient means.

The resilient means can be a coil spring. Further the movable collar can include a circumferential generally u-shaped recess around its outer perimeter, wherein the circumferential U-shaped recess is adapted to receive a container for holding solid preparations. Further, sealing means can be positioned between the container and the movable collar or collar member and between the movable collar and the passage member, wherein at least one of the sealing rings can be an O-ring.

Further, the movable collar can be provided with an inner sleeve that surrounds a perimeter of the passage member. The exit opening or dispensing orifice can be positioned in the bottom of the housing. The passage member is an extension of the passage or guiding passage and fixed to the housing, wherein the passage preferably has a restricted portion. There may be an upstanding wall which extends from the bottom, parallel to the restricted portion and spaced there from at a predefined distance. Also the movable collar has a depending wall, which is adapted to slide along the upstanding wall. Furthermore, the dispenser can include a detector for monitoring the dispensing of each solid preparation, especially of each unit dose thereof, dispensed.

The detector can be a laser detector. Further, a dispenser system can comprise a dispenser including an electronic circuit and an energy supply for monitoring, controlling and/or communication. In such an embodiment the energy supply includes a battery and the electronic circuit includes a microcontroller, wherein the electronic circuit preferably includes a first transceiver. Such an embodiment may further comprise an alarm signal generator, wherein the alarm signal generator can be selectable to generate an audible signal by means of a buzzer. The alarm signal generator can include a vibrator. Further, a dispenser system can further comprise an electromechanical blocking mechanism for blocking relative movement between the movable collar or collar member and the housing and/or between the passage member and the movable collar or collar member. The dispenser system can further include an LCD display for transferring messages. Further, the system can comprise the dispenser system as mentioned before and a docking station. In this case, the docking station has a communication link for the exchange of data with an auxiliary data communication device. Further, the docking station is arranged for data communication with an auxiliary device in the form of a mobile platform, such as a mobile phone. The system comprising an electronic circuit and a first transceiver may comprise a docking station which includes a second transceiver, wherein the first and second transceiver use Near Field Communication technology. Additionally, the docking station can also include an USB interface, wherein the communication link includes an USB-connection. A container and a dispenser may cooperate as a dispenser device and also a container and a dispenser system may cooperate as a dispenser device or a dispenser system. The container as mentioned above is a container with an absorber function obtained by an absorber component. Also it is possible that the absorber component is an integral component of the material the container is made from. The method of monitoring a patient's medication compliance can comprise
a. providing a dispenser system which dispenser system tracks at least one type of patient medicine compliance data, said dispenser system being connected to a container,
b. providing a wave energy transmitter and a power source to drive said transmitter for transmission of said patient's medicine compliance data to a remote location, said transmitter being electronically connected to said dispenser system for said transmission and said data transmitter and power source being connected to said container,
c. providing a receiver at said remote location and providing a computer to which said receiver inputs patient compliance data,
d. having either said dispenser system or said computer programmed to store the prescribed medicine dosage and regime of said container,
e. having either said device or said computer programmed to calculate compliance requirements for each dosage administration for the prescription period of the medicine and for comparing the actual medicine consumption or container usage with the compliance requirements.

Preferably a dispenser system as described above is used for carrying out the invention. For this purpose further especially a container is used with an absorber function obtained by an absorber component.

1-38. (canceled)

39. A dispenser for dispensing solid preparations, the dispenser comprising:
a housing having a dispensing orifice,
a collar member having a receiving opening, and
a passage member having a receiving chamber,
wherein at least one of the housing and the passage member are movable relative to the collar member between a first position, in which the receiving chamber is in receiving communication with the receiving opening of the collar member, and a second position, in which the receiving chamber is in dispensing communication with the dispensing orifice of the housing.

40. The dispenser according to claim 39, wherein the passage member closes the receiving opening when reaching its second position.

41. The dispenser according to claim 39, wherein the passage member is centrally arranged in the housing.

42. The dispenser according to claim 39, wherein the receiving chamber is dimensioned for accommodating one unit dose of a solid substance or a solid preparation to be dispensed.

43. The dispenser according to claim 39, wherein the collar member comprises a circumferential outer fringe at its perimeter providing connecting elements that are suitable for interacting with corresponding connecting elements provided at a dispensing opening of a medication bottle.

44. The dispenser according to claim 39, wherein sealingly interacting parts or elements are arranged in at least one of the following configurations:
between or respectively at the passage member and the collar member;
between or respectively at the collar member and a container interacting therewith;
between or respectively at the housing and the collar member; and
between or respectively at the housing and the passage member to provide an air and/or moisture tight seal, respectively.

45. The dispenser according to claim 39, further comprising a detector for monitoring the dispensing of the solid preparation.

46. The dispenser according to claim 39, further comprising a mechanical or electromechanical blocking mechanism for releasably blocking relative movement between the collar member and the housing and/or between the passage member and the collar member and/or for releasably blocking the closure covering the dispensing orifice.

47. The dispenser according to claim 39, further comprising an electronic circuit and an energy supply for monitoring, controlling, indicating and/or communication.

48. The dispenser according to claim 39, further comprising a container being in dispensing and/or receiving communication therewith and providing a substance and/or solid preparation to be dispensed, wherein the container is in permanent dispensing and/or receiving communication therewith.

49. The dispenser according to claim 48, wherein the container is a medication container and is equipped with an electronic temperature sensor and/or an electronic humidity sensor positioned such that the temperature and/or humidity within the container are measured, wherein the container and/or the dispenser is further equipped with an electronic circuit that receives readings from the electronic temperature sensor and/or the electronic humidity sensor, and stores and/or transmits said readings to an external device.

50. The dispenser according to claim 49,
wherein the circuit further receives information and/or commands from an external source,
wherein the information comprises an acceptable temperature and/or humidity range for the solid preparation contained in the container and/or an expiration date for the solid preparation in the container calculated based on the temperature and/or humidity readings sent to the external device, and/or
wherein the commands comprise a command to alert the user that the temperature and/or humidity readings sent to the external device are outside of an acceptable temperature and/or humidity range.

51. The dispenser according to claim 49,
wherein the container or the dispenser further comprises a blocking device that prevents access to the solid preparation stored in the container, and
wherein the commands comprise a command to activate the blocking device to prevent access to the solid preparation if the preparation has been stored at a temperature and/or humidity outside of an acceptable temperature and/or humidity range.

52. A dispenser system comprising a dispenser according to claim 48,
wherein at least one of the dispenser and the container comprises an electronic circuit and/or an energy supply for monitoring, controlling, indicating and/or data communicating,
and wherein the electronic circuit comprises:
a sensor configured to detect a dispensing event of a single dose of the medication from the dispenser;
a memory that stores information associated with the dispensing event; and
a transceiver that wirelessly transmits the information associated with the dispensing event to an external device
and/or wherein the electronic circuit comprises:
a temperature sensor and/or a humidity sensor positioned to detect the temperature and/or humidity of medication stored in the dispenser and/or the container, and
wherein the electronic circuit is further configured to communicate information relating to the temperature and/or humidity to an external device.

53. The dispenser system according to claim 52, wherein the dispenser communicates with a second dispenser to coordinate the administration of medication from the dispenser and the second dispenser.

54. A method of monitoring a patient's medication compliance using the dispenser according to claim 39, the method comprising:
a. providing a dispenser system that tracks at least one type of patient medicine compliance data, said dispenser system being connected to a container,
b. providing a wave energy transmitter and a power source to drive said transmitter for transmission of said patient's medicine compliance data to a remote location, said transmitter being electronically connected to said dispenser system for said transmission and said data transmitter and power source or supply being connected to said container,
c. causing either said dispenser system or said computer to store the prescribed medicine dosage and regime of said container,
d. causing either said device or said computer to calculate compliance requirements for each dosage administration for the prescription period of the medicine and to compare the actual medicine consumption or container usage with the compliance requirements, and/or wherein the method further comprises:
e. providing a receiver at said remote location and providing a computer to which said receiver inputs patient compliance data

55. A method of monitoring a patient's medication compliance using the dispenser system according to claim 52, wherein the method comprises:
a. providing a dispenser system that tracks at least one type of patient medicine compliance data, said dispenser system being connected to a container,
b. providing a wave energy transmitter and a power source to drive said transmitter for transmission of said patient's medicine compliance data to a remote location, said transmitter being electronically connected to said dispenser system for said transmission and said data transmitter and power source or supply being connected to said container,
c. causing either said dispenser system or said computer to store the prescribed medicine dosage and regime of said container,
d. causing either said device or said computer to calculate compliance requirements for each dosage administration for the prescription period of the medicine and to compare the actual medicine consumption or container usage with the compliance requirements, and/or wherein the method further comprises:
e. providing a receiver at said remote location and providing a computer to which said receiver inputs patient compliance data.
